(19) United States
(12) Patent Application Publication
(10) Pub. No.: US 2024/0334886 A1
(43) Pub. Date: Oct. 10, 2024

(54) PLANTS GROWTH MANAGEMENT SYSTEM AND METHOD

(71) Applicant: ARUGGA A.I FARMING LTD, Even Yehuda (IL)

(72) Inventors: Iddo GELTNER, Even Yehuda (IL); Yoav OR-CHEN, Givat Haim (IL); Nadav ROTEM, Kadima-Zoran (IL); Gali BLECHER, Nir David (IL)

(73) Assignee: ARUGGA A.I FARMING LTD, Even Yehuda (IL)

(21) Appl. No.: 18/293,592

(22) PCT Filed: Aug. 1, 2022
(86) PCT No.: PCT/IL2022/050829

§ 371 Date: Jan. 30, 2024

(30) Foreign Application Priority Data
Aug. 1, 2021 (IL) 285260

(51) Int. Cl. A01G 9/12; A01G 22/05; B25J 5/00; B25J 9/16; B25J 15/08

(52) U.S. Cl. CPC A01G 9/126; B25J 5/007; B25J 9/1697; B25J 15/083; A01G 22/05

(57) ABSTRACT

A plants management/treatment system is disclosed comprising at least one robotic arm system configured to reciprocally move along a longitudinal axis thereof towards or away suspension devices placed on a cable, a manipulator coupled to the at least one robotic arm and configured to grip one of the suspension devices between gripping fingers thereof and manipulate it to adjust at least one of suspension height of the plant coupled to the suspension device, or location of the suspension device along the cable, and at least one sensing unit coupled to the at least one robotic arm and configured to detect location of one of the suspension devices suspended from the cable, and generate signals/data to cause the at least one robotic arm to reciprocally move along the longitudinal axis to grip the suspension device and manipulate it.

### TECHNOLOGICAL FIELD

The present application generally relates to agricultural automated systems, and, more particularly, to robotic arm system and method for performing various growth management and/or treatment tasks of plants.

### BACKGROUND

Agricultural robots are increasing production yields for farmers in various ways. From drones to autonomous tractors to robotic arms, this technology is being deployed in many innovative applications. These robots automate slow, repetitive and dull tasks for farmers, allowing them to focus more on improving overall production yields. Some of the most common robots in agriculture are used for harvesting and picking, weed control, autonomous mowing, pruning, seeding, spraying and thinning, and also for sorting and packing.

Harvesting and picking is one of the most popular robotic applications in agriculture due to the accuracy and speed that robots can achieve to improve the size of yields and reduce waste from crops being left in the field. However, there are many other innovative ways the agricultural industry is deploying robotic automation to improve production yields.

Plants' growth management processes are very different from picking and placing a metal part on an assembly line. The agricultural robotic arm must be flexible in a dynamic environment and accurate enough not to damage the plants as they are being treated. For Example, robotic arms must navigate environments with many obstacles to delicately grasp and place a pepper.

Layering/leveling is a very common practice in agriculture and is performed when the plant's head reaches a certain height. For example, in large scale growing facilities specially designed hooks (also referred to herein as suspension devices) are used to hang, support, and intermittently or periodically lower the plants (e.g., tomatoes, cucumbers, or suchlike). The layering/leveling hook is a double-sided hook device having upper-side and bottom-side hooks, a central twine spooling portion between said hooks, and a twine spooled thereover, but other configuration thereof can be similarly used. The layering/leveling hook is attached to a trellis cable by one of its hooks, and a free end of the twine is connected to a portion of the plant for supporting the plant. As the plant grows, portions of the spooled twine are released from the layering/leveling hook to lower the plant, in order to alleviate the distribution of water by the plant to its top portions, and to facilitate harvesting of the ripe fruits.

Generally, the lowering is carried out by a worker who holds and lifts the hook to detach its upper-side hook from the trellis cable, rotates the layering/leveling hook by 180°, sideway displaces the layering/leveling hook a certain distance (e.g., about 10 to 30 cm), and places it back on the trellis cable. As the layering/leveling hook is rotated by 180° its bottom-side hook becomes the upper-side hook, and vice versa. This procedure lowers the plant by half-wire-rotation-around-the-hook length e.g., about 20 cm. The plant typically grows about 20 cm per week, and thus the lowering should be performed once a week to comply with the plants growth rate. In addition, the lowering assists the pickers to easily reach the bottom part of the plant where they need to harvest the ripe fruits.

In this layering/leveling process, at approximately 20,000 plants per hectare, and a few seconds spent on each plant every week, the costs of the layering/leveling task may be about $1000/hectare/month. Another associated difficulty is the limited number of employees in agriculture. The lack of suitable human labor may disrupt the routine layering/leveling procedures, thus reducing quality of the plants, which can bend and break if not supported by attaching them to the trellis cable, and lowered properly from time to time, or if workers have a hard time reaching the fruits, that may cause dropping and losing yield. The need to reduce dependency on manual labor, and to automate these tasks, is thus vital.

Some agricultural automation solutions known from the patent literature are briefly described here below.

US Patent publication No. 2015/173297 describes a device for selectively harvesting crops on a plant. The device can include a picking apparatus. The picking apparatus can be rotatable around a central axis. The picking apparatus can include a plurality of grippers each spaced apart and extending radially from the central axis, and each configured to pick a different individual one of the crops. Each of the plurality of grippers can be adjustable between an open position and a closed position. Each of the plurality of grippers can be configured in the open position to open around the individual crop. Each of the plurality of grippers can be configured in the closed position to securely hold the individual crop when the picking apparatus is rotated around the central axis.

US Patent Publication No. 2015/142250 describes an autonomous vehicle platform and system for selectively performing an in-season management task in an agricultural field while self-navigating between rows of planted crops. The autonomous vehicle platform having a vehicle base with a width so dimensioned as to be insertable through the space between two rows of planted crops, the vehicle base having an in-season task management structure configured to perform various tasks, including selectively applying fertilizer, mapping growth zones and seeding cover crop within an agricultural field.

US Patent Publication No. 2008/046130 describes an agricultural automation system for use in an agricultural area which includes an implement caddy carrying a plurality of implements, an elongate transport structure, and a field robot movable along the elongate transport structure. The field robot includes an arm movable in at least one direction different from the movement along the elongate transport structure. The field robot interfaces with the implement caddy for coupling the arm with at least one selected implement, such as a tool or sensor.

European Patent Publication No. 3,714,682 discloses a gripping apparatus to relocate a high-wire hook comprising a pair of opposite loops for wrapping there around a rope; and a pair of suspension hooks, a respective hook located in the proximity of a respective loop, for hanging the high-wire hook on a hanging wire; whereby the high-wire hook is configured to support a high-wire crop in horticulture by hanging the high-wire hook by one of the suspension hooks on the hanging wire; and whereby the rope wrapped around the loops supports an ending of the high-wire crop; and wherein the gripping apparatus comprises a gripping mechanism comprising a protuberance; a robot arm coupled to the gripping mechanism; and a processing unit operatively coupled to the robot arm; and wherein the processing unit actuates the robot arm to insert the protuberance in one of the loops for relocating the high-wire hook.

### General Description

There is a need in the art for automated systems configured for efficient growth management tasks, such as plants layering/leveling e.g., for relatively high-weighted plants, while also having a suitable relatively compact dimensions/size as to allow it to operate in an agricultural area/facility. The present application provides agricultural automated plants growth management/treatment systems and techniques configured to efficiently carry out such tasks. In one broad aspect there is provided a robotic arm system configured to manipulate a suspension device (also referred to herein as a layering/leveling hook) from which a portion of a plant is suspended, for lowering and/or displacing the suspended portion of the plant with respect to a trellis cable. The robotic arm system is configured to travel along the cable, identify a suspension device hanging from the trellis cable, and detach the suspension device from the trellis cable for lowering, or elevating, at least some portion of the plant and/or displacing it. Accordingly, in some embodiments, the robotic arm system is configured to reciprocally move towards, or away from, the trellis cable for approaching the identified suspension device and detach it from the trellis cable for lowering at least some portion of the plant and/or displacing the location of the suspension device along the trellis cable.

In some embodiments the suspension device is a type of layering/leveling double hook device having a spooled twine/wire connected to a portion of the plant by a free end thereof. In such embodiments the robotic arm system is configured to release a portion of the spooled twine/wire for lowering the suspended plant portion. For this purpose, the robotic arm system comprises in some embodiments a rotatable gripper configured to grip the suspension device and release a portion of the spooled twine/wire by rotating the suspension device by 180°. In addition, in order to detach the suspension device from the trellis cable, the system is further configured in some embodiments for controlled elevation or lowering of the robotic arm system with respect to the trellis cable.

Alternatively, in other possible embodiments, the robotic arm system is configured to reciprocally move towards, or away from, the trellis cable for approaching the identified suspension device and detach it from the trellis cable for elevating at least some portion of the plant and/or displacing the location of the suspension device along the trellis cable. In such possible embodiments the robotic arm system is configured to spool a portion of the released twine/wire for elevating the suspended plant portion. In a similar fashion, the rotatable gripper of the robotic arm system can be configured to grip the suspension device and spool thereover a portion of the released twine/wire by counter-rotating the suspension device by 180°.

In order to displace the suspension device along the trellis cable, in some embodiments, the robotic arm system is further configured for rotary movement of the gripper/manipulator about a rotary axis thereof. This way, the movement of the robotic arm system can be stopped whenever a suspension device is identified, the robotic arm is then moved towards the identified suspension device for engagement with the gripper to grip the suspension device by the gripper, slightly elevate the robotic arm to detach the upper-side hook of the suspension device from the trellis cable, and after the suspension device is 180° rotated by the gripper to release a portion of the spooled twine (or to spool a portion of the released twine), the robotic arm can be rotated about its rotary axis for displacing the gripped suspension device a defined distance along the trellis cable.

In some embodiments the robotic arm system can be moved along the trellis cable while the robotic arm (which holds the suspension device) is maintained substantially horizontal (i.e., parallel to the ground surface) and perpendicular to the trellis cable, in order to displace the gripped suspension device a defined distance along the trellis cable.

The robotic arm can then hang the suspension device back from the trellis cable by moving the robotic arm towards the trellis cable until it's currently upper-side hook (previously the bottom-side hook) of the suspension device is located above the trellis cable, lowering the robotic arm and releasing its grip over the layering/leveling suspension device/hook, to place the layering/leveling suspension device/hook back on the trellis cable by its current upper-side hook.

In order to perform layering/leveling of relatively high-weighted plants (e.g., a typical tomato plant can weight about 10 Kg), suitable robotic arms that can lift such relatively high weights are required. However, robotic arms intended for such high-weighted payloads are expensive and usually too big and cumbersome to fit in an agricultural environment, while smaller robotic arms and Cobots are limited in terms of handling such high-weighted payloads.

Generally, the payload limit of a robotic arm is determined by the maximum torque that the farthest joint from the tip (typically a gripper) can apply. When a force is acting on the gripper of the robotic arm, it induces a corresponding torque on the farthest joint. Additionally, robotic arms intended for treating/lifting large payloads have high-power requirements, since high electric currents are required to drive the joint motor, all amounting to the cost of the robot. For example, for a typical line width in a glasshouse, assuming that an actuator is located at the middle of the robotic arm, and that the plants weight is about 10 Kg, then the amount of torque required to perform the lifting is about 60 Nm.

In order to overcome the limitation derived from maximum torques of the actuators, the following configurations are contemplated in the embodiments disclosed herein:
the weight carrying element of the robotic arm that performs the task is configured as a rigid beam capable of withstanding the payload and the bending force acting on it during its operation;
to reduce the stress acting on the system structure, the robotic arm can be configured to lean on the trellis cable when it is lifting the layering/leveling suspension device/hook, thereby supporting the robotic arm by the trellis cable during operation; and
the gripper fingers can be configured to implement at least one of the following gripping methods: male-female type gripping which can be used as a main gripping method, wherein the suspension device/hook is captured/trapped between the gripper fingers i.e., using friction force for the gripping, which can be used as a secondary/additional method that ensures the suspension device/hook cannot slip down;
form closure e.g., utilizing a patterned attachment/gripping surface(s) configured to prevent suspension device/hook slips; and
force closure, wherein the force closure i.e., using friction force, can be used as a main gripping method, and the form (e.g., patterned attachment) closure may be used as a secondary/additional method that ensures the suspension device/hook cannot slip down e.g., by squeezing the suspension device/hook between the ‘fingers’ of the gripper such that the friction (which can be increased using rubber) prevents the slip.

Any combination of these gripping methods can be implemented in the embodiments disclosed herein.

As mentioned, revolute joints used in Cobots, and small robotic arms can provide for only limited torque levels, resulting in limited payloads. The embodiments disclosed herein utilize a telescopic mast, or a type of scissor elevation (lift) mechanism, capable of lifting and holding the plant weight (e.g., 10 Kg), which can be used for other agricultural tasks (e.g., pollination). The robotic arm can utilize a screw-driven base rail to provide sufficient vertical force and self-locking options that reduce the motor duty/load cycle. This way, the design of the robotic arm system needs to ensure that the plant weight is carried only by the vertical degree of freedom of the robotic arm, which is in some embodiments a screw-based actuator. The suggested design ensures that no actuation, other than intended, occurs against the plant weight, but in a direction perpendicular thereto. Similarly, in possible embodiments, a pneumatic linear actuator in utilized for the reciprocal movement of the robotic arm towards/away the trellis cable.

In one aspect the subject matter disclosed herein is directed to an automated plants management and/or treatment system. The system comprising at least one robotic arm system configured to reciprocally move a robotic arm thereof along a longitudinal axis thereof towards or away from suspension devices placed on a cable, each suspension device supporting at least one plant coupled to the suspension device, a manipulator/gripper coupled to the at least one robotic arm and configured to receive and immobilize one of the suspension devices between gripping fingers thereof and manipulate it to adjust at least one of suspension height of the plant coupled to the suspension device, or location of the suspension device along the cable, and at least one sensing unit coupled to the at least one robotic arm such that its field-of-view is not affected by the manipulation of said suspension device by the manipulator. The at least one sensing unit is configured to detect location of one of the suspension devices suspended from the cable, and generate signals/data to cause the at least one robotic arm to reciprocally move along said longitudinal axis to grip the suspension device and manipulate it.

The longitudinal axis of the robotic arm is in some embodiments substantially horizontal (i.e., parallel to the ground surface) perpendicular in some embodiments to a direction of gravitational forces experienced by the at least one robotic arm i.e., the longitudinal axis of the robotic arm is substantially horizontal/parallel to the ground surface. At least one of the gripping fingers of the manipulator/gripper can be configured to move substantially perpendicular to the elongated axis of the robotic arm for capturing and immobilizing the suspension device between the gripping fingers.

Optionally, but in some embodiments preferably, each one of the suspension devices includes a spooled twine/wine. This way, each of the plants can be coupled to a respective suspension device by a free end of the spooled twine/wire. The gripper can be configured to release a portion of the spooled twine/wire, or to spool a portion of the released twine/wire, for the adjusting of the suspension height of the respective plant. The system comprises in some embodiments a gripper rotating unit configured to rotate the gripper. The gripper can be thus configured to grip the detected suspension device and rotate it by the gripper rotating unit to release portion of spooled wire/twine, or to spool a portion of the released wire/twine.

In some embodiments each robotic arm system is coupled to a respective horizontal rail for sliding motion thereover. Alternatively, or additionally, each robotic arm system is coupled to a respective vertical rail sliding motion thereover. The system comprises in some embodiments two robotic arm systems configured to simultaneously manipulate suspension devices located on respective two different cables at two opposing sides of said system.

The system comprises in some embodiments an adjustable mast, or a scissor elevation mechanism, for controlling the height of the robotic arm. The manipulating of the suspension device can thus comprise elevating the robotic arm by the adjustable mast or a scissor elevation mechanism for detaching the upper-side hook of the suspension device from the cable. For this purpose, the adjustable mast can be equipped with a telescopic mast arrangement. An actuator is used in some embodiments to controllably cause the reciprocal movement of the at least one robotic arm towards and away the suspension device substantially perpendicular to a longitudinal axis of the adjustable mast.

The system can comprise an arm rotating unit configured to apply yaw rotatory motion to the at least one robotic arm. The manipulating of the suspension device may thus comprise detaching the suspension device from the cable and rotating the at least one robotic arm by the arm rotating unit to displace the suspension device some distance on the cable away from a previous location thereof.

The system comprises in some embodiments a movable platform for moving the at least one robotic arm substantially in parallel to the cable. The manipulating of the suspension device can thus comprise displacing the suspension device some predefined distance along the cable by moving the movable platform accordingly along the cable. The signals/data generated by the at least one sensing unit can be used for slowing down and/or stopping the movement of the movable platform.

The system comprises in some embodiments a catcher assembly configured to catch plants and/or suspension devices accidentally detached from the actuator and/or the cable. The system may further comprise a sensing device configured to detect engagement of the catcher assembly with a plant and/or suspension device. In possible embodiments a weighing mechanism coupled to the robotic arm system and configured to generate load/weight data/signals indicative of a weight of a plant, or some portion thereof, coupled to the suspension device. The weighing mechanism can be used to generate measurement signals/data indicative of a weight of at least some portion of a plant supported by a suspension device manipulated by the manipulator of the robotic arm system. The control unit can be accordingly configured and operable to collect, process and/or monitor, weight data/signals of the plants which suspension devices are manipulated by the robotic arm system and/or its manipulator/gripper, and issue and alert if growth anomalies are thereby determined.

The system comprises in some embodiments one or sensors configured to detect accidental release of the suspension device from the manipulator. The control unit can be configured to halt the system upon detection of accident release of the suspension device from the manipulator. Optionally, but in some embodiments preferably, the control unit is configured to manipulate the suspension device whenever the load/weight data/signals from the weighing mechanism is indicative of a plant's weight over the robotic arm.

The system comprises in some embodiments a control unit configured and operable to receive the signals/data generated by the at least one sensing unit, and responsively generate control signals for slowing down or stopping the movable platform and for manipulating the suspension device. The at least one sensing unit can comprise an imager configured to generate imagery data/signal indicative of a location of at least one suspension device on the cable. The control unit can be configured and operable to process and analyze the imagery data/signals generated by the imager, and based thereon generate control signals to manipulate the detected suspension device. Optionally, but in some embodiments preferably, the at least one sensing unit comprises a proximity, and/or contact, and/or optical/imager sensor, configured to generate signals/data indicating that the at least one robotic arm being in proximity to, and/or in contact with, one of the suspension devices.

An auxiliary arm can is coupled in some embodiments to the at least one robotic arm. The auxiliary arm can be configured to contact the cable and at least partially support the at least one robotic arm over the cable. The auxiliary arm can be hinged to the at least one robotic arm. The auxiliary arm can be further coupled to the at least one robotic arm by an elastic element configured to pull the auxiliary arm towards the at least one robotic arm. Optionally, the auxiliary arm comprises a telescopically stretchable component configured to maintain continuous contact over the cable when the suspension device is manipulated by the at least one robotic arm. In possible embodiments the at least one sensing unit comprises a proximity, and/or tactile, and/or optical/imager, sensor provided on the auxiliary arm for indicating proximity to, or contact with one of the suspension devices.

The gripper may utilize at least two gripping fingers configured for gripping the suspension devices. Optionally, at least one of the gripping fingers is controllable movable with respect to the other gripping finger(s) for thereby gripping or releasing the detected suspension device. At least one of the gripping fingers may comprise a recess configured to receive a portion of the detected suspension device for thereby gripping and immobilizing the suspension device by the gripper. In some embodiment at least one of the gripping fingers comprises one or more projections configured to receive a portion of the detected suspension device for thereby gripping and immobilizing the suspension device by the gripper. The gripping fingers may comprise complementary male-female gripping elements configured to receive a portion of the detected suspension device for thereby gripping and immobilizing the suspension device by the gripper.

The actuator comprises in some embodiments a locking pin controllably movable for insertion into a loop of the suspension device. The manipulator can comprise one or more sensors configured to indicate receipt of the suspension device therein, and placement of its loop over passage of the locking pin. The manipulator comprises in possible embodiments a controllably movable immobilizing element configured to anteriorly push an upper portion of the suspension device and rotate the same about the locking pin. The system can comprise an abutment structure configured to stop movement of lower portions of the suspension caused due to the movable immobilizing element.

Another aspect of the subject matter disclosed herein is directed to a method for automated plants management and/or treatment. The method comprises detecting by at least one sensing unit coupled to at least one robotic arm a location of a suspension device suspended from a cable, moving a gripper device in a non-gripping state thereof along a longitudinal axis of said robotic arm (e.g., the longitudinal axis being substantially perpendicular to a direction of gravitational forces experienced by said at least one robotic arm) towards the suspension device, where the suspension device is supporting at least one plant coupled to the suspension device, receiving the suspension device between gripping fingers of the manipulator and changing the gripper device into a gripping state e.g., by moving at least one gripping finger of the gripper device substantially perpendicular to said elongated axis of the robotic arm e.g., for holding and immobilizing said suspension device therein, and manipulating the suspension device by the gripper device for adjusting at least one of suspension height of the plant coupled to the suspension device, or location of the suspension device along the cable.

The manipulating of the suspension device by the gripper can include releasing a portion of a twine/wire spooled over a portion of the suspension device, or spooling a portion of the released twine/wire, for adjusting suspension height of the at least one plant. The manipulating of the suspension device may comprise rotating the suspension device by the gripper device.

The method may comprise adjusting height of the gripper. The manipulating of the suspension device may comprise elevating the gripper for detaching the suspension device from the cable. The manipulating of the suspension device comprises in some embodiments displacing the suspension device some predefined distance along the cable.

The method comprises in some embodiments moving the gripper device along the cable for detection and manipulation of one or more additional suspension devices placed on the cable. In possible embodiments the method comprises receiving and processing signals/data from at least one sensing unit and responsively slowing down or stopping the moving of the gripper device for manipulating the suspension device whenever the signals/data is indicative of approaching a suspension device.

The method can include receiving weight measurement data/signals for each of the plants supported by the suspension device manipulated by the at least one robotic arm. The method comprises in possible embodiments detecting accidental release of the suspension device from the manipulator. Optionally, all operations of the system are halted responsive to the detection of accidental release of the suspension device from the manipulator, and/or an alert may be issued.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A and 1B schematically illustrate a robotic arm system according to some possible embodiments, wherein FIG. 1A is a general illustration of the robotic arm and

FIG. 1B illustrates the robotic arm system carried by a movable platform;

FIG. 2 schematically illustrates components of the robotic arm according to some possible embodiments;

FIG. 3 schematically illustrates control scheme of the robotic arm system according to some possible embodiments;

FIG. 4 schematically illustrates a robotic arm system according to other possible embodiments;

FIG. 5 shows a top view of the robotic arm according to other possible embodiments;

FIG. 6 schematically illustrates a gripper of the robotic arm according to some possible embodiments having friction imparting elements;

FIG. 7 schematically illustrates another gripper configuration of the robotic arm according to some possible embodiments having a gripping groove;

FIG. 8 schematically illustrates another gripper configuration of the robotic arm according to some possible embodiments having gripping projections;

FIGS. 9A and 9B schematically illustrate a gripper configuration of the robotic arm according to some possible embodiments having male-female configuration;

FIGS. 10A and 10B are flowchart schematically illustrating operation of the robotic arm according to some possible embodiments;

FIG. 11A to 11D schematically illustrate other possible embodiments of the robotic arm system, wherein FIG. 11A exemplifies use of a scissor lift mechanism, FIG. 11B exemplifies a plant catcher mechanism, FIG. 11C exemplifies a double plant treatment configuration, and FIG. 11D exemplifies a manipulator configuration;

FIGS. 12A to 12D schematically illustrate a robotic arm system and its manipulator according to some possible embodiments, wherein FIG. 12A shows a perspective view of the robotic arm system and its manipulator, FIG. 12B shows a side view of the robotic arm system with a suspension device locked to its manipulator, FIG. 12C shows a side view of the robotic arm system with the suspension device locked and immobilized to its manipulator, and FIG. 12D is a flow chart of robotic arm management procedure according to some possible embodiments.

### DETAILED DESCRIPTION OF EMBODIMENTS

The various embodiments of the present invention are described below with reference to the drawings, which are to be considered in all aspects as illustrative only and not restrictive in any manner. In an effort to provide a concise description of these embodiments, not all features of an actual implementation are described in the specification. Elements illustrated in the drawings are not necessarily to scale, or in correct proportional relationships, which are not critical. Emphasis instead being placed upon clearly illustrating the principles of the invention to allow persons skilled in the art to make and use it, once they understand its principles. This invention may be provided in other specific forms and embodiments without departing from the essential characteristics described herein.

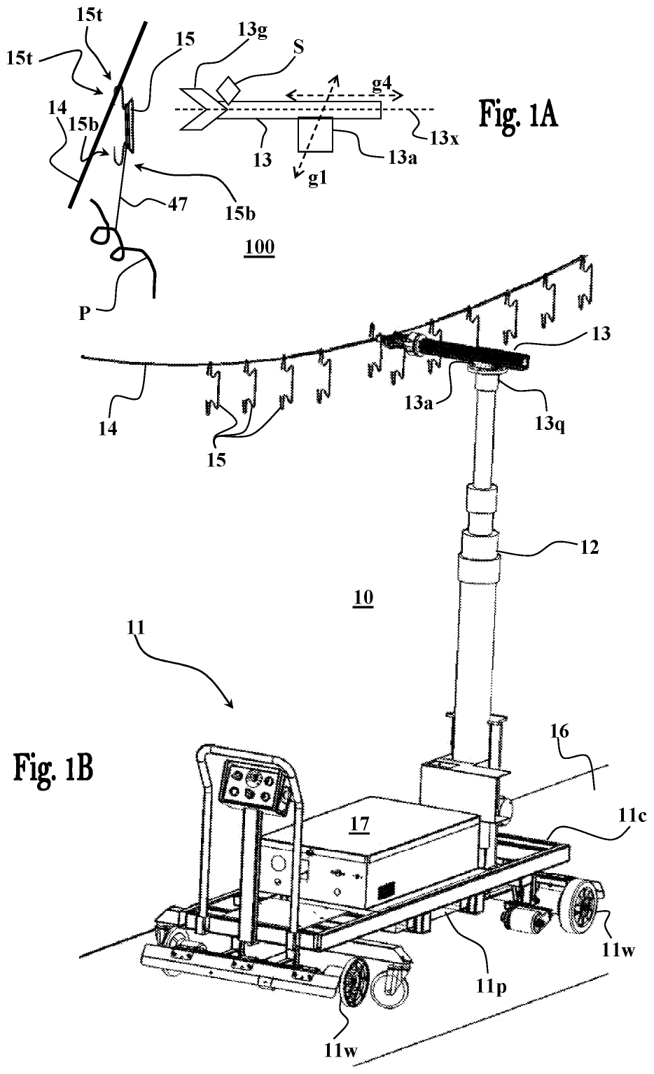

Reference is made to FIG. 1A schematically illustrating an agricultural automated plants growth management/treatment system 100 according to some possible embodiments. The system 100 can be configured to perform various tasks associated with growth management (e.g., layering/leveling) of plants in an “agricultural area”. The term “agricultural area” should be interpreted herein broadly including agricultural fields, and types of plant growing facilities, such as, farmhouses, greenhouses, and the like.

As shown, a portion of a plant P is attached by a spooled wire/cable/twine/spool 47 to a suspension device 15, which in this non-limiting illustration, is a double hook layering/leveling structure/device. The suspension device 15 is hanging from a cable 14 (typically a trellis cable) by its upper-side hook 15t, while its bottom-side hook 15b is maintained loose, such that the plant P is suspended by suspension device 15 from the cable 14 via the spooled twine/wire, which maintains/holds and supports the plant P at a certain height from the ground (73 in FIG. 3). Typically, such cables 14 include a plurality of suspension devices such as the suspension device 15 disposed thereon, however, to facilitate understanding, only one such device 15 is shown in FIG. 1A.

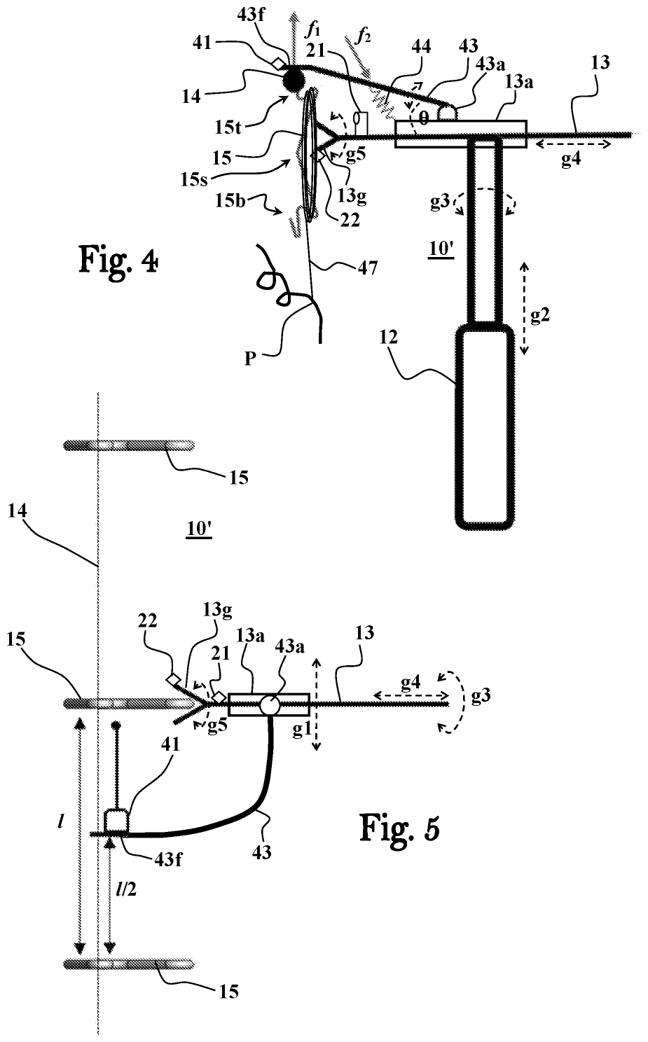

As shown, the plant P is attached to the suspension device 15 via the suspension twine/wire 47, which is typically spooled about a central portion of the suspension device 15, and is connected to at least a portion of the plant P, thus allowing it to be supported at a certain suspension height from the ground surface (73), as will be described further below with reference to FIG. 4. In practice, the plant is typically winded around/about the suspension twine/wire 47 along its full length, or clipped to it.

The system 100 includes a robotic arm 13 which can move substantially in parallel to (along) the cable 14 from which the plant P is suspended by the respective suspension device 15. More specifically, the robotic arm 13 can controllably move along a path/axis defined along the cable 14, such that a longitudinal axis of the robotic arm 13 is substantially horizontal (i.e., parallel to the ground surface 73) and substantially perpendicularly (g1) to the cable 14.

The robotic arm 13 is also configured to move reciprocally (g4) with respect to the suspension device 15 and/or the cable 14, namely towards, or away from, the cable 14, along a longitudinal axis 13x of the robotic arm 13, thereby allowing it to reach the suspension device 15 in order to manipulate it. To this end, the robotic arm 13 can be associated with/coupled to an actuator 13a (e.g., a linear actuator, such as, a screw-driven base rail, an electric linear actuator, a pneumatic actuator, etc.) adapted to enable such reciprocal movement of the robotic arm 13, towards the cable and away from the cable 14. The actuator 13a is further adapted to withstand torques applied thereto (e.g., about 40 to 60 Nm) so as to allow the robotic arm 13 to manipulate the suspension devices 15.

It should be noted that the payload limit of a robotic arm, i.e., the weight that the robotic arm can lift, is generally determined by the farthest joint from the tip of the robotic arm. Specifically, in system 100, when the robotic arm 13 manipulates the suspension device 15, a force is acting on the tip/edge portion (at distal end) of the robotic arm 13. This force is proportional to the weight of the payload that the suspension device 15 is typically carrying, i.e., the weight of the plant P. While acting on the robotic arm 13, this force applies a corresponding torque on the actuator 13a, which in the embodiments disclosed herein is not utilizing a joint mechanism, but a linear or pneumatic actuator.

For example, a typical tomato plant weight is about 10 Kg inducing a torque of about 45 to 65 Nm on the actuator 13a. Thus, in the illustrated embodiments, the reciprocal movement affected by the actuator 13a is substantially perpendicular to the direction of the gravitational force applied by the suspended plant, thereby permitting relatively large elongation of the robotic arm 13 under substantial loads acting on the gripping end (13g). This way, the robotic arm is adapted to withstand relatively high torques, and enable actuating the robotic arm 13 to manipulate the suspension devices with relatively low power demands.

The system 100 also includes at least one sensing unit S (e.g., camera/imager, proximity sensor, tactile sensor, or suchlike, or any combination thereof) coupled to/mounted on the robotic arm 13. The sensing unit S is configured for detecting location of the suspension devices 15 suspended from the cable 14, while the robotic arm 13 moves substantially parallel to/along the cable 14. Upon detection of a certain suspension device 15 on the cable 14, the sensing unit S generates signals/data for causing the robotic arm 13 to stop in front of the detected suspension device 15, and reciprocally move with respect to the suspension device 15 and manipulate it.

The system 100 also includes a gripper/manipulator 13g rotatably attached/coupled to the robotic arm 13, by which the robotic arm 13 manipulates the suspension device 15. In particular, the gripper 13g is configured to manipulate one of the suspension devices 15 (once being detected) suspended from the cable 14, for adjusting/varying the suspension height of the plant P with respect to the ground (73) and/or the location of the suspension device 15 along the cable 14.

In this specific and non-limiting example, the system 100 travels/moves (g1) along the cable 14, which is associated with a certain single row of plants P. It should however be noted that agricultural fields/greenhouses can include many rows of plants and a corresponding separate cable in each row of plants. The system 100 disclosed herein can be configured to move between such rows, i.e., between two cables on opposite sides of the robot. More specifically, upon reaching the end of a cable 14, the system proceeds to the next row. To this end, the sensing unit S is further configured in some embodiments for detecting the cable 14 in order to determine when the system 100 reaches the end of the cable 14. Accordingly, as the system 100 reaches the end of the cable 14 it can move to operate at the next row of plants.

Reference is made to FIG. 10A illustrating, a generalized flow-chart of a process 200 for managing/treating growth of plants according to some possible embodiments. The process 200 includes moving a robotic arm system along a cable, in parallel (S1) to the cable from which the plants are suspended from by respective suspension devices. As described hereinabove, the robotic arm system (100) is controllably movable reciprocally with respect to (towards and away) the suspension devices (15).

The process 200 further includes detecting location of one of the suspension devices (S2) that are suspended from the cable (14), while the robotic arm moves substantially parallel to/along the cable, and generating signals/data for causing the robotic arm to reciprocally move with respect to the suspension device and to manipulate it (S3). When the robotic arm reaches the end of the cable (S4), it can move to the next row of plants (S5), or otherwise, if the end of the cable is not reached, it continues to move along the cable (S1) and manipulate further suspension device suspended therefrom (if any/detected).

Reference is now made to FIG. 1B schematically illustrating an agricultural automated plants growth management system 10 according to some possible embodiments. The system 10 includes an autonomous movable platform 11 configured and operable to move along a path/trail (or rail) 16 substantially in parallel to a cable 14 (e.g., a trellis cable). The cable 14 carries a plurality of suspension devices 15, disposed along the cable 14. Each suspension device 15 can be associated with a corresponding plant (not shown), which is suspended from the cable 14 via the corresponding suspension device 15. The autonomous movable platform 11 is so dimensioned as to be moved between two typical rows of planted crops. Particularly, the linear actuation of the robotic arm 13 towards/away from the cable 14 guarantees that its operation will not interfere/harm plants suspended from an adjacently located/parallel cable (not shown).

The autonomous movable platform 11 can have a base platform 11c and a plurality of ground engaging wheels 11w operably coupled to the base platform 11c. The ground engaging wheels 11w can include various types of wheels allowing the autonomous movable platform 11 to operate effectively across a range of surface conditions created by different cultivation methods (e.g., no-till, low-till, strip-till, and conventional tillage), and on different soil types with different crop types. In some embodiments the ground engaging wheels 11w are configured to directly engage the ground (73), or a rail (e.g., pipe rail) system passing along the cable 14.

The autonomous movable platform 11 can have at least one power train/unit 11p fixedly coupled to the base platform 11c, and operably coupled to at least one ground engaging wheel 11w. In one embodiment, an internal combustion engine, fueled by diesel or gasoline, can be the main power source for powertrain. In another embodiment a battery and/or the electric grid can be the main power source for powertrain. In yet another embodiment, a conventional engine can be paired/combined with a battery to create a hybrid power system.

The autonomous movable platform 11 can also include a control system/unit 17 coupled to the power unit 11p. The control unit 17 is configured and operable for operating the autonomous movable platform 11, as will be described in detail further below with reference to FIG. 3.

The system 10 includes the robotic arm 13, which is moved by the autonomous movable platform 11 substantially in parallel to/along the cable 14, from which the plurality of plants are suspended from by the suspension devices 15. As mentioned, the robotic arm 13 is configured to controllably move reciprocally with respect to the suspension devices 15 disposed on the cable 14, and manipulate the suspension devices 15 to adjust suspension height of portions of the plants and/or translate them along the cable 14.

The robotic arm 13 is rotatably coupled to an adjustable mast unit 12 (e.g., a telescopic mast) such that it is rotatable in a plane substantially perpendicular to an axis of the adjustable mast unit 12 i.e., the robotic arm 13 is rotatable around/about the elongated axis of the adjustable mast unit 12. The adjustable mast unit 12 is fixedly attached to the autonomous movable platform 11. The adjustable mast unit 12 is configured in some embodiments to bring the robotic arm 13 to a desired height from the ground (73), namely to a height of the suspension devices 15, whose height can vary due to the change in the height of the cable 14, so as to allow the robotic arm 13 to manipulate the suspension devices 15 suspended from the cable 14.

In this specific and non-limiting example, the robotic arm 13 is coupled to the adjustable mast unit 12 by the actuator 13a. The actuator 13a can be mounted to a first rotating unit (e.g., motor axle) for rotating the robotic arm 13 about the longitudinal axis of the adjustable mast unit 12.

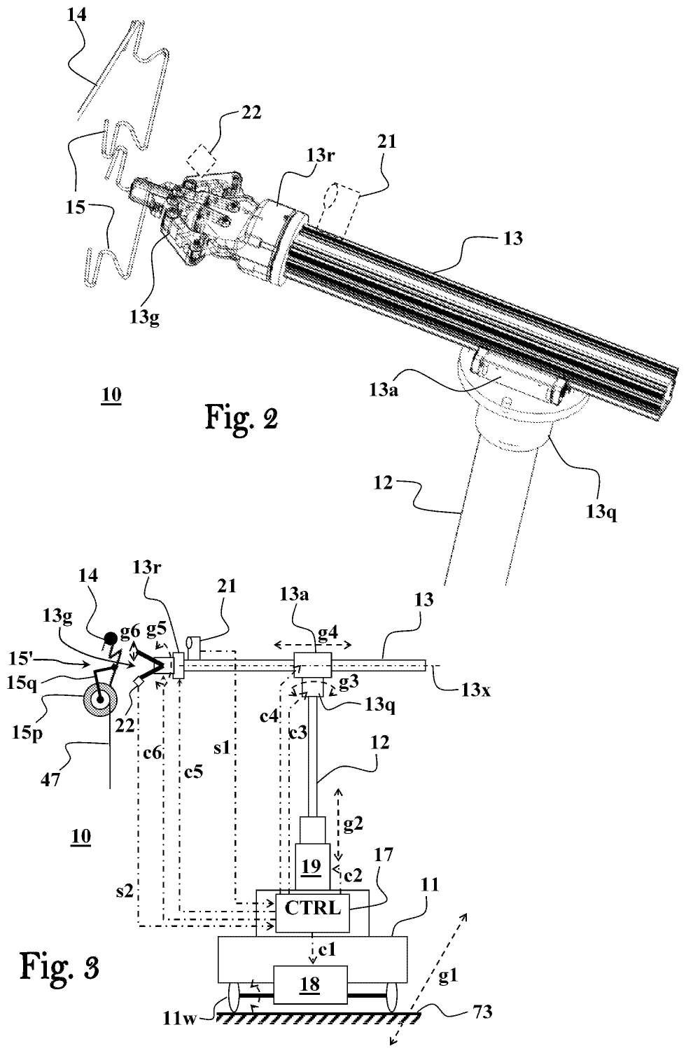

Reference is now made to FIG. 2 showing a closer view of the robotic arm 13. As shown, the robotic arm 13 is mounted in possible embodiments on the adjustable mast unit 12 (e.g., a telescopic mast) via the first rotating unit 13q (e.g., rotary joint) that is configured to provide/enable rotation of the robotic arm 13 in a plane substantially perpendicular to the adjustable mast unit 12 i.e., around/about the elongated axis of the adjustable mast unit 12.

As mentioned, the robotic arm 13 is configured to move reciprocally with respect to the suspension device 15 thereby detected, so as to reach the suspension device 15 in order to manipulate it. This is achieved by an actuator 13a (e.g., screw-driven base rail, electric linear, pneumatic, etc.) which can be located on the rotating unit 13q and fixedly/rigidly attached thereto. This actuator 13a is adapted to enable such reciprocal movement of the robotic arm 13 towards and away from the suspension device 15 and/or the cable 14.

The robotic arm 13 includes in some embodiments a sensing unit 22 coupled thereto and configured for detecting location of the suspension devices 15 suspended from the cable 14, while moving the robotic arm 13 substantially parallel to/along said cable. The sensing unit 22 can be configured to generate signals/data upon detection of a suspension device 15 on the cable 14 for causing the robotic arm 13 to reciprocally move with respect to said suspension device 15, and manipulate it. These signals/data may be communicated to a control unit (17), which in turn, receives and processes these signals and operates the robotic arm 13 accordingly, as will be described further below.

Alternatively, or additionally, the robotic arm 13 can include an optical unit 21 (e.g., imager/camera) which generates optical data signals for causing the robotic arm 13 to reciprocally move with respect to (towards/away) said suspension device 15, and manipulate it. Accordingly, in possible embodiments the detection of the suspension devices 15 is carried out using only the optical unit 21 (e.g., utilizing image processing techniques) configured to identify the location of the suspension device 15 on the cable 14. In other possible embodiments, the detection of the suspension devices 15 is carried out using only the sensing unit 22, which may be a type of proximity (or tactile or optical/imager) sensor configured to sense the presence of the suspension device and generate data/signals indicative thereof.

In yet other possible embodiments, the optical unit 21 and the sensing unit 22 are both used for detection of the suspension devices 15 disposed on the cable 14. For example, and without being limited, in possible embodiments the optical unit 21 is used for generating an initial indication whenever a suspension device 15 enters into its field of view (FOV), to signal the system that robotic arm 13 is approaching a suspension device 15, and that motion of the system 10 along the cable 14 should be slowed down until signals/data from the sensing unit 22 indicates that the robotic arm 13 is located proximal to (or contacts) the suspension device 15. In this configuration, the signals/data from the sensing unit 22 can be used to further slow and finally stop the motion of the system 10 along the cable 14, until the gripper 13g of the robotic arm 13 becomes located in front of the suspension device 15. Further signals/data generated by the optical unit 21 can be then used to guide the robotic arm 13 towards the suspension device 15 for gripping it by the gripper 13g, and/or to adjust the height of the robotic arm 13 by the adjustable mast unit 12 on which it is mounted.

In yet other possible embodiments, the sensing unit 22 is used for generating an initial indication whenever it senses (or contacts) a suspension device 15 in its proximity to signal the system that the robotic arm 13 is approaching a suspension device 15 and that motion of the system 10 along the cable 14 should be slowed down until signals/data from the optical unit 21 indicates that the robotic arm 13 is located in front of the suspension device 15, and that the motion of the system 10 along the cable 15 should be stopped. In this configuration, the signals/data from the sensing unit 22 can be also used to further slow and finally stop the motion of the system 10 along cable 14 until the gripper 13g of the robotic arm 13 becomes located in front of the suspension device 15. Similarly, further signals/data generated by the optical unit 21 can be used to guide the robotic arm 13 towards the suspension device 15 for gripping it by the gripper 13g, and/or to adjust the height of the robotic arm 13 by the adjustable mast unit 12.

As also mentioned, the robotic arm 13 has a gripper 13g rotatably mounted in one of its extremities, and configured to manipulate one of the suspension devices 15 (once being detected) on the cable 14. The gripper 13g is coupled/attached to the robotic arm 13 via a second rotating unit/actuator 13r, which is mounted on the robotic arm 13 and configured to carry the gripper 13g and to allow rotation of the gripper 13g in a plane substantially perpendicular to the elongated axis of the robotic arm 13 i.e., the second rotating unit/actuator 13r is configured to rotate the gripper 13g around/about the elongated axis 13x of the robotic arm 13.

In the embodiments disclosed herein the rotating unit/actuator 13r is configured to rotate the gripper/manipulator 13g about the elongated axis 13x of the robotic arm 13, or about and axis that is substantially parallel to the elongated axis 13x of the robotic arm 13. Optionally, but in some embodiments preferably, the axis of rotation of the gripper/manipulator 13g and the elongated axis 13x of the robotic arm 13 are both in a plane that is substantially perpendicular to the ground surface (73) and to the cable (14).

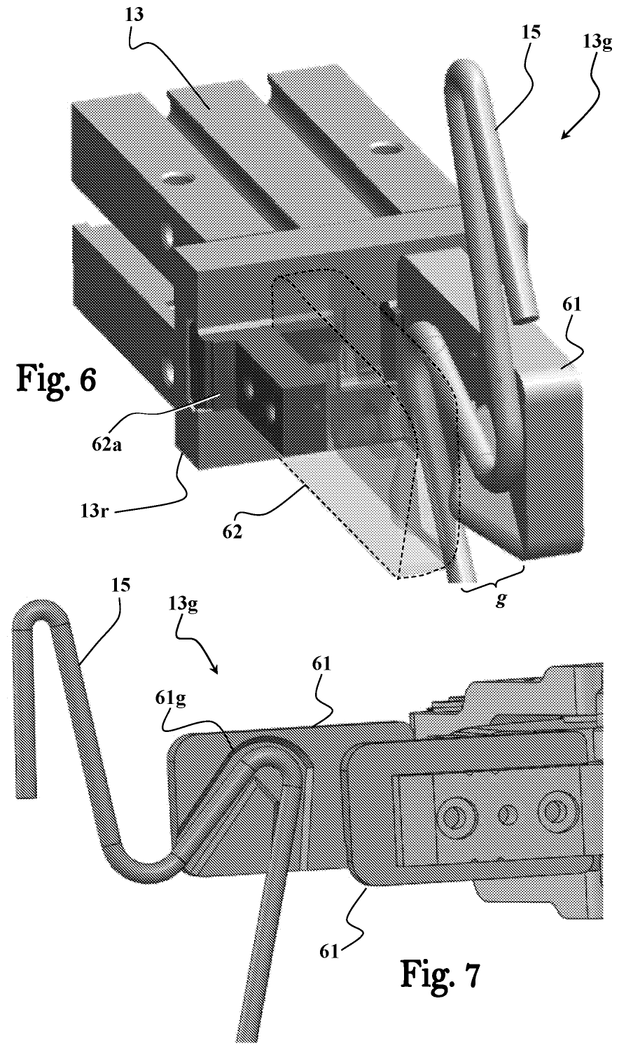

As will be demonstrated herein below with reference to FIGS. 6 to 8, FIG. 9A and FIG. 9B, the gripper 13g can be configured to form a claw-like structure. The gripper 13g is configured to receive the suspension device 15 between gripping fingers/members thereof, and to manipulate it. To this end, in operation, the gripper 13g can be shiftable between a gripping (closed) and a non-gripping (open) state. More specifically, upon detection of a certain suspension device 15 disposed on the cable 14, the gripper 13g in its open state is moved by the robotic arm 13 towards the suspension device 15 for receiving the suspension device between its gripping fingers/members. Once the suspension device 15 is received between the gripping fingers/members, the gripper 13g is changed into its closed state for fixedly gripping the suspension device 15 between its gripping fingers/members, so as to allow manipulation thereof.

Reference is made to FIG. 3 schematically illustrating a control scheme of the agricultural automated plants growth management/treatment system 10, according to some possible embodiments. The system 10 can include a control system (CTRL) 17 in signal/data communication with the sensing unit 22, and/or the camera 21. The control system 17 is configures for receiving data/signals (s2) from the sensing unit 22, and/or receiving optical data/signals (s1) from the camera 21.

The control system 17 is also configured for processing these data/signals and for generating control signals c1-c6 for operating/actuating, respectively, the engine 18 (c1) to rotate one or more of the wheels 11w, the elevation actuator 19 (c2) to adjust the height of the adjustable mast unit 12 and thereby the height of the robotic arm 13 mounted thereon, the first rotating unit 13q (c3) for rotating the robotic arm 13 about the longitudinal axis of the adjustable mast unit 12, the actuator 13a (c4) for reciprocally moving the gripper 13g towards or away with respect to the cable 14, the second rotating unit/actuator 13r (c5) for rotating the gripper 13g and thereby manipulating the suspension device 15′ (15 in FIGS. 1, 2 and 4-8), and the gripper 13g for changing its gripping fingers/members between their closed and open states (c6). Thus, the engine 18, the elevation actuator 19, the first rotating unit 13q, the actuator 13a, the second rotating unit/actuator 13r, and the gripper 13g, are responsive to the control signals c1-c6 from the control system 17.

The system 10 has a plurality of freedom degrees of movement denoted by g1-g6 which are defined by movement profiles of various parts of the system 10. More specifically, the system 10 has a freedom degree of movement g1 of the autonomous movable platform 11, g2 of the adjustable mast unit 12, an additional three freedom degrees of movement g3-g5 of the robotic arm 13, and g6 of the gripping fingers/members of the gripper 13g. In particular, the power unit 18 is mechanically coupled to the ground engaging wheels 11w of the autonomous movable platform 11, so as to enable movement of the system 10 substantially in parallel to/along the cable 14 (g1). The adjustable mast unit 12 (e.g., a telescopic mast) mounted on the autonomous movable platform 11 and driven by the elevation actuator 19, which enables the adjustable mast unit 12 to vary its height, namely, to extend and retract along its elongated axis (g2). The robotic arm 13 is mounted to the adjustable mast unit 12 and coupled thereto by the first rotating unit 13q (e.g., rotary joint), which allows it to rotate in a plane substantially perpendicular to the adjustable mast unit 12 and around/about its elongated axis (g3). The robotic arm 13 is also coupled to the actuator 13a (e.g., screw-driven base rail, electric linear, pneumatic, etc.) allowing it to move reciprocally (g4) with respect to the cable 14, namely, towards and away from the cable 14. The gripper 13g is coupled/attached to the robotic arm 13 via the second rotating unit/actuator 13r configured to allow controllable rotation of the gripper 13g in a plane substantially perpendicular to the robotic arm 13, and around/about an elongated axis of the robotic arm 13.

In some embodiments the robotic arm 13 is fixedly attached to the adjustable mast unit 12 i.e., without using the first rotating unit 13q (e.g., rotary joint) to rotate the robotic arm 13 around/about the elongated axis to the adjustable mast unit 12. In such embodiments adjusting the location of the gripper 13g with respect to the suspension devices 15 is achieved by moving the autonomous movable platform 11 (g1), elevating or lowering the robotic arm 13 by the adjustable mast unit 12 (g2), and reciprocal movement of the robotic arm 13 towards/away the suspension device 15 (g4) i.e., without the rotational movement g3 of the robotic arm 13.

These degrees of freedom of movement g1-g6 enable the system 10 to perform various plant growth management/treatment assignments/tasks (e.g., layering/leveling). As will be appreciated by the versed artisans, this configuration provides the system 10 with generic freedom movement degrees g1, g2 and g3, that can be adapted to support other possible plant treatment tasks (reaching all plants and various parts of the plant), while the freedom movement degrees g4, g5 and g6, can be adapted for more specific plant treatment task (e.g., pollination, harvesting, etc.). This design of the system 10 is therefore very efficient economically.

As mentioned, the gripper 13g is configured for manipulating the suspension devices on the cable 14. Such a manipulation of the suspension devices can include adjusting/varying suspension height of a certain plant attached to a corresponding suspension device and/or relocation of the suspension device along the cable 14. More specifically, the manipulation can include, inter alia, gripping the suspension device 15, detaching it from the cable 14, rotating the suspension device to release a portion of the spooled twine/wire (or to spool a portion of the released twine/wire), and placing the suspension device 15 on a different/displaced (or same) location on the cable 14.

Alternatively, as demonstrated in FIG. 3, in possible embodiments the suspension device 15′ may be a type of hook device having a drum 15p on which the twinc/wire 47 is spooled. In such embodiments the gripper 13g is configured to manipulate the suspension device 15′ to release from the drum 15p some predetermined portion of the spooled twine/wire 47. For example, the system 10 can be configured to cause a stopper arm 15q to release its engagement over the drum 15p, to thereby cause release of the predetermined portion of the spooled twine/wire 47 by the gravitation force applied by the suspended plant (not shown). Alternatively, in possible embodiments, the gripper 13g is configured to rotate the drum 15p in a defined direction for releasing the predetermined portion of the spooled twine/wire 47. In a similar manner, the gripper 13g can be configured to rotate the drum 15p in an opposite direction for spooling a predetermined portion of the released twine/wire 47 back onto the drum 15p.

As also seen in FIG. 3, in possible embodiments the optical unit (imager) 21 and the longitudinal axis 13x of the robotic arm 13 are substantially in a plane that is vertical to the ground surface i.e., in a plane that is substantially vertical to the cable 14 and/or the direction of movement g1 of the movable platform 11. In this specific and non-limiting example the optical unit (imager) 21 is mounted on the robotic arm 13, such that it reciprocally moves towards/away from the cable 14 together with the manipulator/gripper 13g, but it may be similarly mounted on other parts (e.g., actuator 13a) of the system that are not affected by the reciprocal movement of the robotic arm system 13.

Generally, in possible embodiments, the optical unit (imager) 21 is fixedly mounted to the robotic arm 13 in a fixed distance from its longitudinal axis 13x. Optionally, but in some embodiments preferably, the position of the optical unit (imager) 21 is maintained fixed and unchanged with respect to the longitudinal axis 13x of the robotic arm 13, such that their relative position and angle(s) is fixed and known i.e., in possible embodiments the longitudinal axis 13x of the robotic arm 13 is not necessarily parallel to the ground surface 73. This way, the field-of-view (FOV) of the optical unit (imager) 21 over the manipulator/gripper 13g, the cable 14 and the suspension devices 15/15′, is maintained substantially unchanged during the operation of the system 10.

Reference is made to FIG. 10B illustrating a detailed flow-chart of a process 210 of managing growth of plants according to some possible embodiments. The process 210 includes moving the robotic arm system (10) along the cable (14) in parallel (Q1) to the cable from which the plants (P) are suspended by their respective suspension devices (15). The method further includes detecting a suspension device (Q2) along the cable. Once detected, the robotic arm (13) is moved (Q3) forward and/or up/down towards the suspension device (15) and the state of the gripper (13g) is changed for gripping the suspension device (Q4) by setting the gripper fingers/members into their gripping state.

The process 210 further includes elevating the robotic arm (Q5) by the adjustable mast unit (12), thereby detaching the suspension device (15) from the cable (14) and moving the robotic arm (13) backwards (Q6) away from the cable (14). The process 210 further includes rotating the suspension device (Q7) by rotating the gripper (13g) about a longitudinal axis of the robotic arm a selected rotation angel (e.g., 180º, or a number of 180° rotations), thereby releasing (or spooling) a portion of the spooled (released) twinc/wire (47) and lowering the height of the suspended plant (P).

The process 210 can further include rotating/steering the robotic arm (Q8) (while holding the suspension device 15) about a longitudinal axis of the adjustable mast unit (12) in a direction generally opposite to the general direction of movement of the robotic arm along the cable, or in the general direction of movement of the robotic arm along the cable, for displacing the suspension device (15) some predetermined distance along the cable (14). Alternatively, but in some embodiments preferably, step Q8 of the process 210 can include moving the robotic arm system (10) while the robotic arm (13) holds the suspension device (15) along the cable (14) in parallel (g1) to the cable in a direction generally opposite to the general direction of movement of the robotic arm along the cable, or in the general direction of movement of the robotic arm along the cable, for displacing the suspension device (15) the predetermined distance along the cable (14) e.g., if the system 10 is implemented without the g3 freedom degree of movement i.e., without the rotating unit 13q.

The process 210 further includes moving the robotic arm (13) forward (Q9) towards the cable (14) and lowering the robotic arm (Q10) by the adjustable mast unit (12). The process 210 further includes releasing the suspension device (Q11) onto the cable at a selected location on the cable (14), said selected location is displaced from the previous location of the suspension device (15) in a direction opposite to the general direction of movement of the robotic arm along the cable (14), or in the general direction of movement of the robotic arm along the cable. The process 210 further includes moving the robotic arm (13) backwards (Q12) i.e., away from the cable. Optionally, if the robotic arm 13 has been rotated about the longitudinal axis of the adjustable mast in step Q8, then de-rotating of the robotic arm (13) (optional step indicated by dashed box Q13) about the elongated axis of the adjustable mast unit (12) can be performed, to return the robotic arm (13) to its initial angular position substantially perpendicular to the cable (14).

Then, if the robotic arm (13) reaches the end of the cable/row of plants (Q14), it can move to the next row (Q15), otherwise it continues to move along the cable (Q1) for detecting and manipulating any further suspensions devices (15) disposed therefrom (if any/detected).

Generally, each cable/trellis cable (such as cable 14) in an agricultural field and/or in a greenhouse supports, have many (hundreds of) plants suspended therefrom by corresponding suspension devices (15) located along the cable. In order to meet these requirements, this type of cables is typically strong and robust to carry such weights, and it is typically supported every several meters. Accordingly, these physical properties of the cable can be utilized to decrease the torque induced on at least one of the actuators of the system, e.g., on the actuator 13a.

In this connection reference is made now to FIGS. 4 and 5 schematically illustrating an agricultural automated plants growth management system 10′ according to some other possible embodiments of the present disclosure. The agricultural automated plants growth management system 10′ is substantially similar to the system 10 described hereinabove with reference to FIGS. 1B to 3, and thus the same reference numerals are used to designate same, or similar, elements of systems 10 and 10′.

In the agricultural automated plants growth management system 10′ the robotic arm 13 further includes an auxiliary arm 43 rotatably coupled thereto via a joint 43a, and optionally a sensing unit 41 coupled to the auxiliary arm 43 in addition to, or instead of, the sensing unit 22 and/or the optical unit 21. The auxiliary arm 43 is configured for leaning on the cable 14 at a location anterior, and laterally displaced, with respect to the robotic arm 13, i.e., slightly forwardly exceeding the gripper 13g, and laterally displaced in a direction opposite to the direction of movement of the robotic arm 13 along the cable 14. The auxiliary arm 43 has a front portion 43f, which is slightly tilted with respect to the auxiliary arm 43, and by which it engages/interacts with the cable 14, such that the front portion 43f is supported on the cable 14 while the robotic arm 13 is moved along the cable 14, and while it manipulates the suspension device 15.

In some possible embodiments the joint 43a is coupled directly to the robotic arm 13, and the auxiliary arm 43 is configured as an adjustable/telescopic arm (i.e., extending and retracting) such that when the robotic arm 13 moves reciprocally (g4) with respect to the suspension device 15 so as to reach the suspension device 15 in order to manipulate it, the auxiliary arm 43 extends and retracts in accordance with the movement of the robotic arm 13, to thereby maintain continuous contact with the cable 14.

In this specific and non-limiting example, the joint 43a is fixedly attached to the actuator 13a of the robotic arm 13, such that the auxiliary arm 43 remain substantially stationary when the robotic arm 13 is reciprocally moved towards or away from the suspension device. The joint 43a is adapted to allow rotary movement of the auxiliary arm 43 about a rotation axis substantially perpendicular to the elongated axis of the robotic arm 13, as defined by the joint 43a. More specifically, the auxiliary arm 43 is movable angularly/circularly about the rotation axis, thereby varying an angle θ between the auxiliary arm 43 and the robotic arm 13. As better shown in FIG. 5, the auxiliary arm 43 can be rotated together with the robotic arm 13 about the rotation axis defined by the elongated axis of the adjustable mast unit 12 (g3), if such freedom degree of movement is implemented in the system 10.

In some embodiments, the auxiliary arm 43 lags/follows behind the robotic arm 13, as the robotic arm 13 travels/moves along the cable 14, thereby preventing physical contact with the suspension device 15 when the robotic arm 13 manipulates the suspension device 15.

In operation, the front portion 43f of the auxiliary arm 43 slides on top and along the cable 14, as the plants growth management system 10′ is moved along the cable 14 until it is sensed by one or more of its sensing units, 21, 41 and/or 22, to indicate that the robotic arm is located in proximity to one of the suspension devices 15, and that the motion of the system 10 along the cable should be slowed down and stopped to locate the gripper 13g in front of the detected suspension device 15. The sensing unit 42 and the optical unit 21 can be used to implement any of the detection and motion control schemes described hereinabove.

The sensing unit 41 coupled to the auxiliary arm 43 can be also used in some embodiments to implement these detection and motion control schemes instead of, or in addition to the sensing unit 22 coupled to the gripper 13g. Alternatively, in some embodiments, the sensing unit 41 coupled to the auxiliary arm 43 is a proximity (or tactile or optical/imager) sensor configured to generate signals/data indicating that the robotic arm 13 is located proximal to one of the suspension devices 15, and that motion of the system 10 along the cable should be slowed down, or stopped. The data/signals from optical unit 21 can be then used to adjust the location of the system 10′ along the cable 14, in order to locate the gripper 13g in front of the suspension device 15.

Upon detection of a certain suspension device 15 on the cable 14, as the auxiliary arm 43 supportably slides on the cable 14 by its front portion 43f, the robotic arm 13 is actuated to grasp the suspension device 15 in order to lift and elevate it to detach it from the cable 14. The leaning of the auxiliary arm 43 on the cable 14 as the robotic arm 13 lifts the suspension device 15 provides that the load of the suspended plant is divided between the adjustable mast unit 12 and the auxiliary arm 43 being supported by the cable 14, thus reducing the torque acting on the actuator 13a, and on the second rotating unit/actuator 13r, while it is manipulating the suspension device 15.

It should be understood that in operation, when the robotic arm 13 is elevated by the adjustable mast unit 12 to detach the suspension device 15 from the cable 14, a force f₁ can be exerted on the auxiliary arm 43 which can possibly detach the auxiliary arm 43 from the cable 14. In order to maintain the auxiliary arm 43 in contact with the cable 14, the auxiliary arm 43 and the robotic arm 13, or its actuator 13a, are operationally linked/connected by an elastic element 44 (e.g., a spring), such that the robotic arm 13 is movable towards and away from the auxiliary arm 43 against the tension of the clastic element 44. The clastic element 44 generates a “compensating” force f₂ having a component that is in a direction opposite to the direction of the force f₁. This provides that the force generated by the auxiliary arm 43 on the cable 14 is maintained, thus forcing the auxiliary arm 43 to lean on the cable 14 as the robotic arm 13 moves towards and away from the auxiliary arm 43.

The clastic element 44 can be configured such that at small θ angles, namely when the robotic arm 13 is elevated to its maximal desired height, and therefore decreasing the angle θ between the robotic arm 13 and the auxiliary arm 43, the elastic element 44 still exerts such force f₂ sufficient to maintain the auxiliary arm 43 in contact with the cable 14. Optionally, the joint 43a is coupled either to the adjustable mast unit 12, or to any other portion of the robotic arm 13, which does not move backwards/forwards when suspension device 15 is thereby manipulated. Additionally, or alternatively, the auxiliary arm 43 comprises a telescopically stretchable component (not shown) configured to operably adjusts its length, in order to maintain continuous contact of its front portion 43f over the cable 14, and to prevent exerting of a string force by the cable 14 against robotic arm 13 and/or damage to the system.

As shown in FIG. 4, the plant P is connected to the suspension device 15 via a wire/twine 47 which is spooled around a central portion 15s of the suspension device 15. The suspension device 15 in FIG. 4 comprises an upper-side hook 15t, a bottom-side hook 15b, and a wire/twine spooling section 15s located between the upper-side hook 15t and the bottom-side hook 15b. When the suspension device 15 is manipulated by the robotic arm 13, i.e., rotated by an angle of 180°, the upper-side hook 15t becomes the bottom-side hook 15b, and vice versa, causing release of an additional portion of the spooled wire 47 from the suspension device 15, thereby reducing height of the plant P with respect to the ground.

In possible embodiments the robotic arm system 10/10′ is configured to manipulate suspension device 15 to effect spooling of a portion of the released twine/wire 47 from the suspension device 15, thereby elevating height of the plant P with respect to the ground. Generally, the wire/twine 47 is clockwise, or counterclockwise, spooled over the spooling section 15s of the suspension device 15, and the control unit 17 can be configured to process imagery data received from the optical unit 21 to determine the direction of rotation (clockwise or counterclockwise) of the gripper 13g, depending on the way the twine/wire 47 is spooled over the spooling section 15s of the suspension device 15.

As shown in FIG. 5, the auxiliary arm 43 is angled in possible embodiments with respect to the robotic arm 13 in order to locate its front portion 43f at a predetermined horizontal distance e.g., less than l/2, wherein l/2 is the horizontal displacement applied by the robotic arm system to each suspension device 15 over the bale 14 (e.g., smaller than 20 cm i.e., l is about 40 cm) so the suspension device 15 can be displaced a distance of about 20 cm closer to the next suspension device, and wherein/is an average distance between two consecutive suspension devices 15 hanging from the cable 14. This way, the robotic arm 13 can be placed between the previously displaced suspension device 15 and the next suspension device 15 to be displaced, leaving room for the auxiliary arm 43, and some distance to travel between the consecutive suspension devices 15 and detect the position of the next suspension device 15.

In addition, the shape of the auxiliary arm 43 is configured in some embodiments to provide sufficient maneuvering space for the gripper 13g to rotate the suspension device 15 after it is detached from the cable 14, without hitting the auxiliary arm 43.

Reference is made to FIG. 6 schematically illustrating a gripper assembly 13g according to some possible embodiments of the present disclosure. The gripper assembly 13g includes a pair of spaced-apart gripping fingers/members 61 and 62. This arrangement of the spaced-apart fingers/gripping members 61 and 62 defines a gap g between the gripping fingers/members 61,62 for receiving the suspension device 15 therebetween. The gripping fingers/members 61 and 62 (or generally at least one of them) is/are shiftable between the non-gripping, and gripping, states of the gripper 13g by movement of the gripping members 61 and 62 (or at least one of them) one towards the other, for capturing/trapping/gripping the suspension device 15, and for releasing the suspension device by movement of the gripping members 61 and 62 (or at least one of them) one away from the other. The movement of the gripping members 61 and 62 (or at least one of them) one away from the other can be carried out by a linear actuator (not shown).

In some embodiments one, or both, of the gripping fingers/members 61,62 of the gripper 13g are configured for angular motion to form an opening angle therebetween in the open state of the gripper 13g, and to change the gripping fingers/members 61,62 into a parallel conformation (i.e., one relative to the other) in the closed state.

As shown in FIG. 6, in some embodiments the gripping finger/member 62 is mounted on/coupled to a holding member 62a which is controllably movably attached in the gripper assembly 13g. The holding finger/member 62a is configured to be movable along an axis substantially perpendicular to the elongated axis of the robotic arm 13, thereby moving the gripping member/finger 62 towards and away from the gripping member/finger 61, for changing the gripper assembly 13g between its open (non-gripping) and closed (gripping) states, and vice versa.

Optionally, and in some embodiments preferably, although not illustrated in FIG. 6, the gripping member/finger 61 may also be associated with/mounted on a corresponding holding member being similar to the holding member 62a, such that both gripping members 61 and 62 can move towards and away from one another.

Reference is made to FIGS. 7-8 and 9A-9B schematically illustrating different configurations of the gripper assembly 13g according to some possible embodiments. FIG. 7 illustrates a configuration of a gripper assembly 13g in which the gripping member/finger 61 includes a recess/rim/socket 61g having a predetermined profile/shape which is adapted for receiving the suspension device 15 therein, such that at least a portion of the suspension device 15 can be fitted within the recess 61g.

More specifically, when the gripper assembly 13g is in its gripping state, i.e., the gripping members/fingers 61 and 62 (or at least one of them) move towards one another, the suspension device 15 is received within the recess/rim/socket 61g such that it is fixedly trapped/captured and immobilized between the gripping members 61 and 62, thereby preventing it from slipping/sliding down while it is being manipulated (e.g., lifted off the cable and/or rotated).

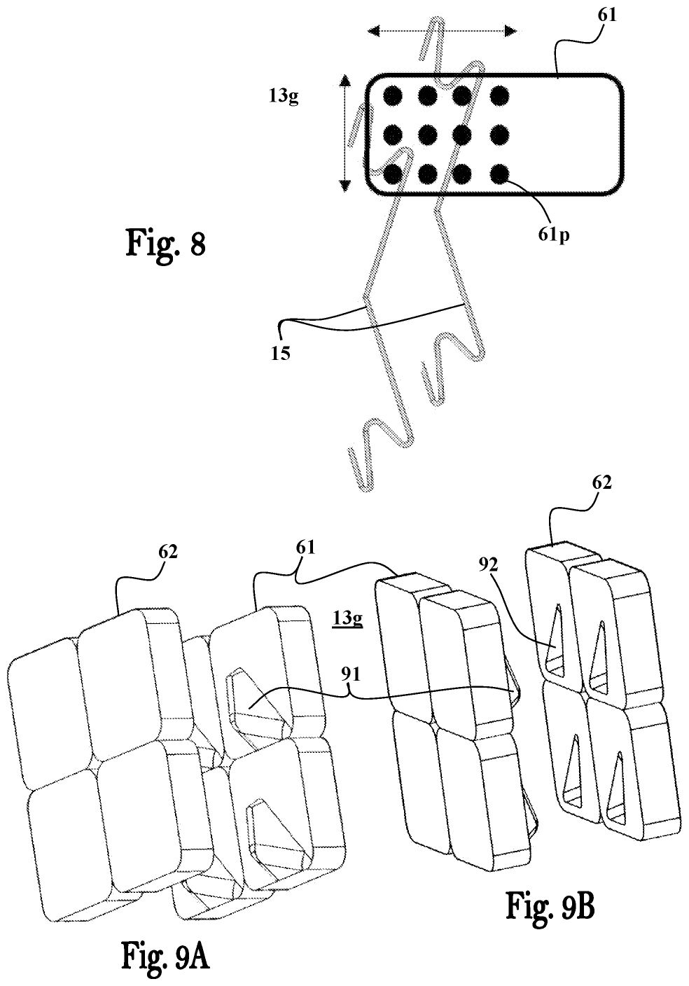

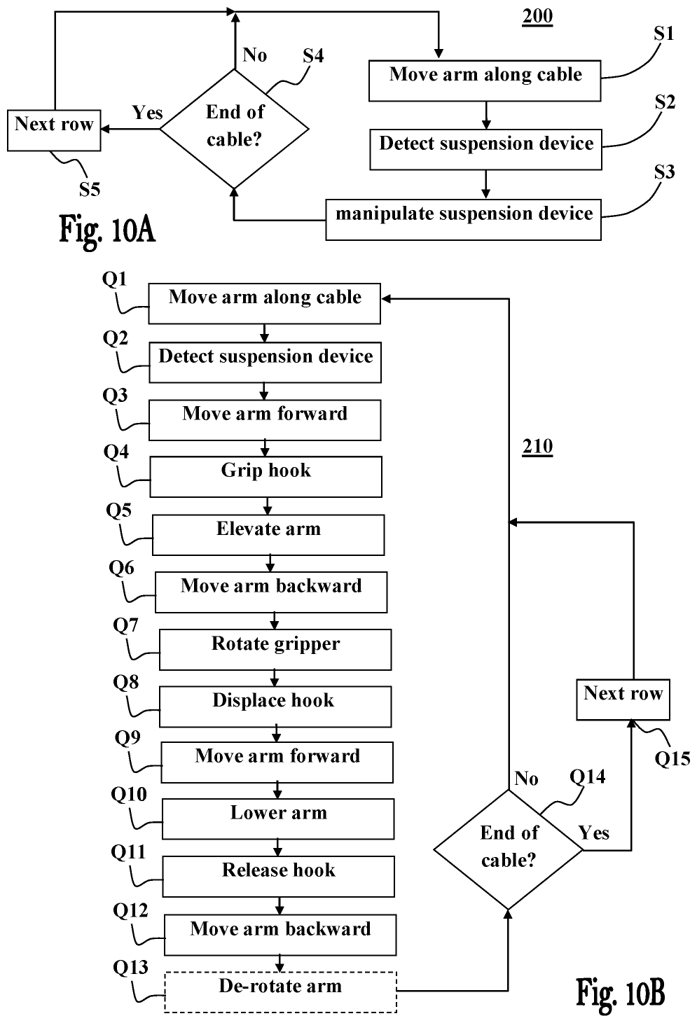

FIGS. 8 and 9 show gripper designs that enable inaccurate positioning of the gripper relative to the suspension device 15, thereby reducing/relaxing the detection requirements of the system i.e., of control unit 17 and/or of the sensor/imager.

FIG. 8 illustrates a male-female configuration of a gripper assembly 13g in which the gripping member 61 includes an arrangement (e.g., a two-dimensional array) of spaced-apart protrusions/finger/pin shaped members 61p. Such an arrangement provides that the suspension device 15 can be fitted and immobilized between at least some of the protrusions/finger/pin shaped members 61p.

The other gripping member/finger 62 (not shown) may have a corresponding arrangement of complementary holes/sockets configured such that when the gripper assembly 13g is changed into its gripping state the finger/pin shaped members 61p of the gripping finger/member 61 are snugly received within the holes/sockets of the gripping finger/member 62, thus trapping/capturing and immobilizing the suspension device 15 therebetween.

FIGS. 9A and 9B schematically illustrate another male-female configuration of a gripper assembly 13g in which the gripping finger/member 61 includes a plurality of projecting elements 91, each having a selected volumetric shape e.g., prism-shaped geometry. The other gripping finger/member 62 includes a plurality of complementary sockets/cavities 92, each adapted for receiving therein the corresponding projecting element 91, such that in the gripping state of the gripper assembly 13g, the suspension device 15 become captured/trapped and immobilized between the projecting elements 91.

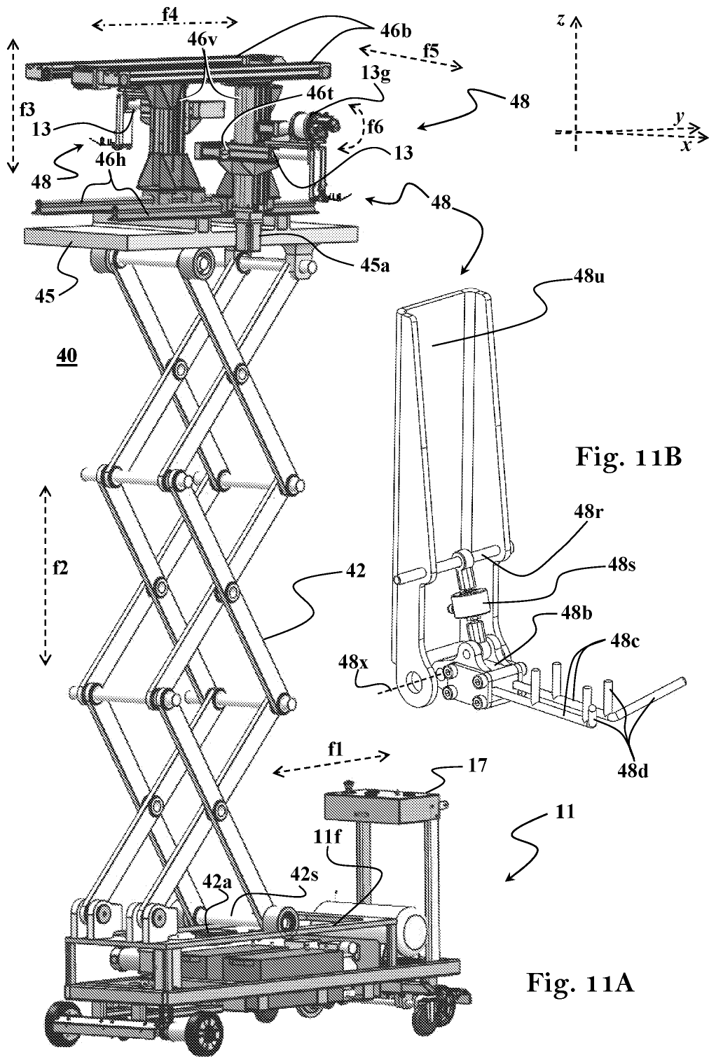

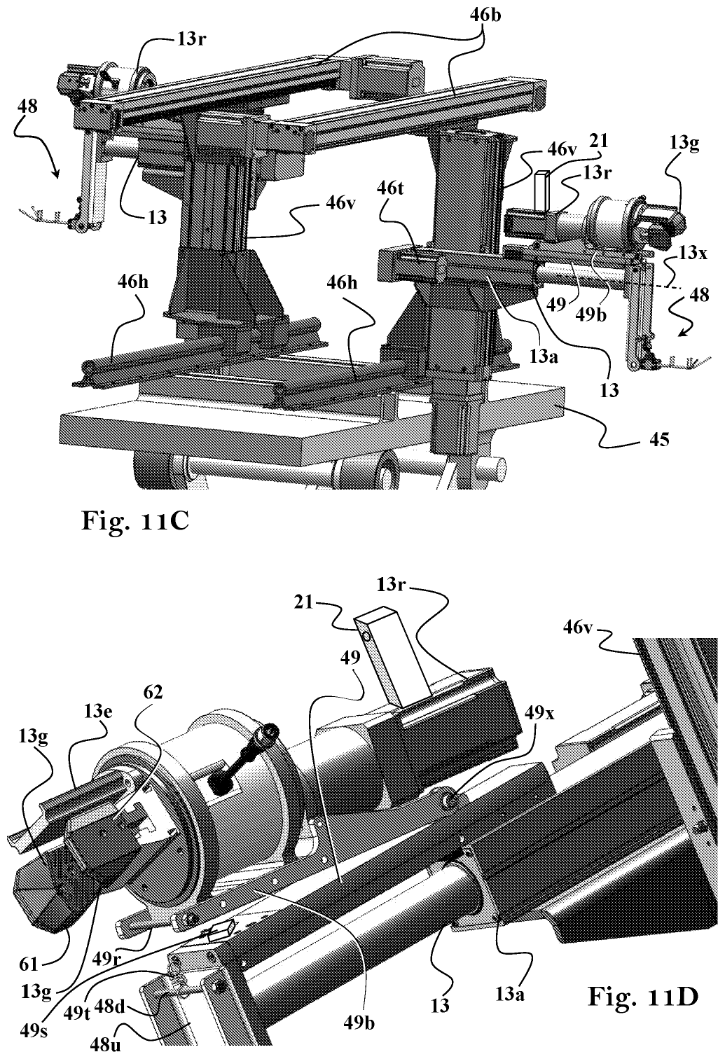

FIGS. 11A to 11D schematically illustrate a plants growth management/treatment system 40 according to some possible embodiments. The system 40 is configured to carry out substantially the same tasks such as carried out by the systems 10/100 described hereinabove with reference to FIGS. 1 to 10, but with few changes derived from its different configuration. Accordingly, same numeral references are used in FIGS. 11A to 11D to designate some of the components having same or similar functionality and/or features, as described hereinabove.

With reference to FIG. 11A, the plants growth management/treatment system 40 utilized a scissor elevation mechanism 42 for elevating or lowering its robotic arm system(s) 13. The movement of the robotic arm system(s) 13 in system 40 is configured differently, such that rotation thereof about the elongated axis of the elevation mechanism 42 is optional in some embodiments, and in this specific example it is altogether not required. Instead, in this specific and non-limiting example one or more robotic arm systems 13 are arranged on a support platform 45 affixed to the upper extremity of the elevation mechanism 42. Each one of the one or more robotic arm systems 13 is configured to detect and manipulate suspension devices (15) suspended from respective different (trellis) cables (14).

This configuration thus requires adding freedom degrees of movement to each robotic arm 13 for allowing the system 40 to detect and manipulate suspension devices (15) hanging from different cables (14) at different heights and locations thereon. As in the other embodiments disclosed hereinabove, the movable platform 11 is configured for forward-backward movements (f1 e.g., along a rail), and the elevation mechanism 42 is configured for up-down movements (f2). However, the elevation mechanism 42 in this specific embodiment utilizes a different actuation mechanism, wherein actuator 42a moves a sliding extremity 42s of the scissor lift over a rail 11f for adjusting the height of the robotic arms 13 with respect to the cables (14) and/or the suspension devices (15) to be thereby manipulated.

In the specific example of FIG. 11A, two robotic arm systems 13 are mounted on the support platform 45. Accordingly, the support platform 45 comprises two respective horizontal rails 46h configured for horizontal sliding motion (f4) of the robotic arm systems 13 thereover using respective controllable actuators 45a. In some embodiments, each robotic arm system 13 is mounted on a vertical support 46v for vertical sliding motion (f3) thereover using respective actuators 46t. Specifically, each vertical support 46v can be movably coupled to a respective horizontal rail 46h for sliding motion thereover, and each robotic arm system 13 can be movably coupled for sliding motion over its respective vertical support 46v. This way, the spatial location in the y-z plane of each robotic arm system 13 can be accurately controlled by the control unit 17.

In some embodiments each robotic arm system 13 may be equipped with a respective balancing beam 46b, configured to balance the robotic arm system 13 and substantially cancel/minimize moments acting thereover while the suspension devices are being thereby manipulated (f6). In some embodiments, the balancing beams 46b are mechanically coupled at their extremities to the support platform 15 e.g., via respective one or more support beams (not shown). Accordingly, the vertical support 46v can be configured for sliding motion of their extremities along the horizontal rails 46h and the balancing beams 46b.

Referring now to FIG. 11B, in possible embodiments each robotic arm system 13 comprises a plant catcher assembly 48 mechanically coupled thereto. The plant catcher assembly 48 is thus moved in the y-z plane as its robotic arm system 13 slides along the horizontal rail 46h, and also along the x-axis/elongated axis of the robotic arm 13 as it reciprocally moves its gripper/manipulator 13g towards/away (f5) the suspension devices.

The plant catcher assembly 48 comprises a plurality of catching fingers 48d located underneath and anterior to the gripper/manipulator 13g of its respective robotic arm 13. In this specific and non-limiting example, the catching fingers 48d extend from a rods 48c anteriorly extending from a “U”-shaped support 48u, which inferiorly extends from the robotic arm system 13. The catching fingers 48d are configured to catch and hold plants which suspension devices' (15) being manipulated by the robotic arm system 13, whenever the grip over the suspension device (15) is inadvertently lost, and thereby prevent damage to the plant coupled to such inadvertently released suspension devices.

In possible embodiments the catching fingers 48d extend anteriorly and superiorly from a palm structure 48b rotatably coupled to the “U”-shaped support 48u for angular movement about axis of rotation 48x. As seen, the palm structure 48b is further coupled to a coupling rod 48r fixedly attached to the sidewalls of the “U”-shaped support 48u. In some embodiments, the palm structure 48b is coupled to the coupling rod 48r via a load sensor 48s configured to detect the catching of falling plants by the catching fingers 48d, whenever their suspension devices are inadvertently released, and issue corresponding alert signals/data indicative thereof to the control system 17. Clearly, the catcher assembly 48 can similarly issue alert if the wires/cables and/or other such obstacles are thereby catch e.g., unexpected interferences in the system operation.

FIG. 11C shows a closer view of the support platform 45, and of the robotic arm systems 13 movably coupled thereto. As exemplified, in some embodiments pneumatic actuators 13a are used for reciprocally moving the grippers 13g towards/away the suspension device (15). In this specific and non-limiting example, the grippers 13g and their actuators 13r, are fixedly coupled to a supporting frame 49b. In this non-limiting example, the supporting frame 49b is coupled to a support plate 49 fixedly coupled to the robotic arm system 13, but in possible embodiments the supporting frame 49b can be similarly attached directly to the robotic arm 13.

Similar to previous embodiments disclosed herein, the optical unit (imager) 21 is mounted on a portion of the robotic arm system 13 that is substantially not affected by the rotary motion of the manipulator/gripper 13g e.g., on the actuator 13r. Particularly, in embodiments disclosed herein the optical unit (imager) 21 and the longitudinal axis 13x of the robotic arm 13 are substantially in a plane that is vertical to the ground surface i.e., in a plane that is substantially vertical to the cable (14). However, as explained hereinabove, the longitudinal axis 13x of the robotic arm 13 is not necessarily horizontal/maintained parallel to ground surface, as long the relative position and angle(s) between the optical unit (imager) 21 and the longitudinal axis 13x of the robotic arm 13, is maintained fixed/known and unchanged.

FIG. 11D shows a closer view of the robotic arm systems 13 according to some possible embodiments, wherein a weighing mechanism is used in the robotic arm system 13 for weighing the plants thereby treated. In this embodiment the supporting frame 49b is movably coupled to the support plate 49 by pivot 49x, thereby enabling angular motion of the supporting frame 49b and the manipulator/gripper 13g coupled thereto, thereabout. One or more sensor elements 49s (e.g., gauge sensors, load sensors, pressure sensors, or suchlike) can be installed between the supporting frame 49b and the support plate 49, for measuring the load on the manipulator/gripper 13g. one or more elastic elements (e.g., springs 49t) may be used to apply counter forces over the supporting frame 49b (i.e., in a direction opposite to the direction to the gravitational forces experienced due to the treated plant). In this specific example, an elastic element 49t is exemplified installed between a road 48d coupled to the “U”-shaped support 48u of the plant catcher assembly 48 for attachment to a rod 49r of the supporting frame 49b, but it may be similarly installed in any appropriate location between the supporting frame 49b and the support plate 49 and/or the robotic arm 13.

In some embodiments the manipulator/gripper 13g comprises a stopper element 13e located above the gripping fingers/members 61,62 and configured to prevent the rotary movement of the suspension device (15) within the finger's 61,62 of the manipulator/gripper 13g e.g., when a full turn of the suspension device is carried out and there is a much larger moment at the gripping area of the suspension device 15, wherein it is held by the gripper/manipulator 13g.

This way, in possible embodiments, the control system (17) can be configured to take weight measurements of each plant thereby treated, and optionally to also monitor based thereon the growth and maturing of each plant individually. The control unit (17) can be further configured to issue alerts whenever the weight measurements taken for one or more of the monitored plants are not withing acceptable ranges e.g., with respect to expected growth curve/rate of the specific plant.

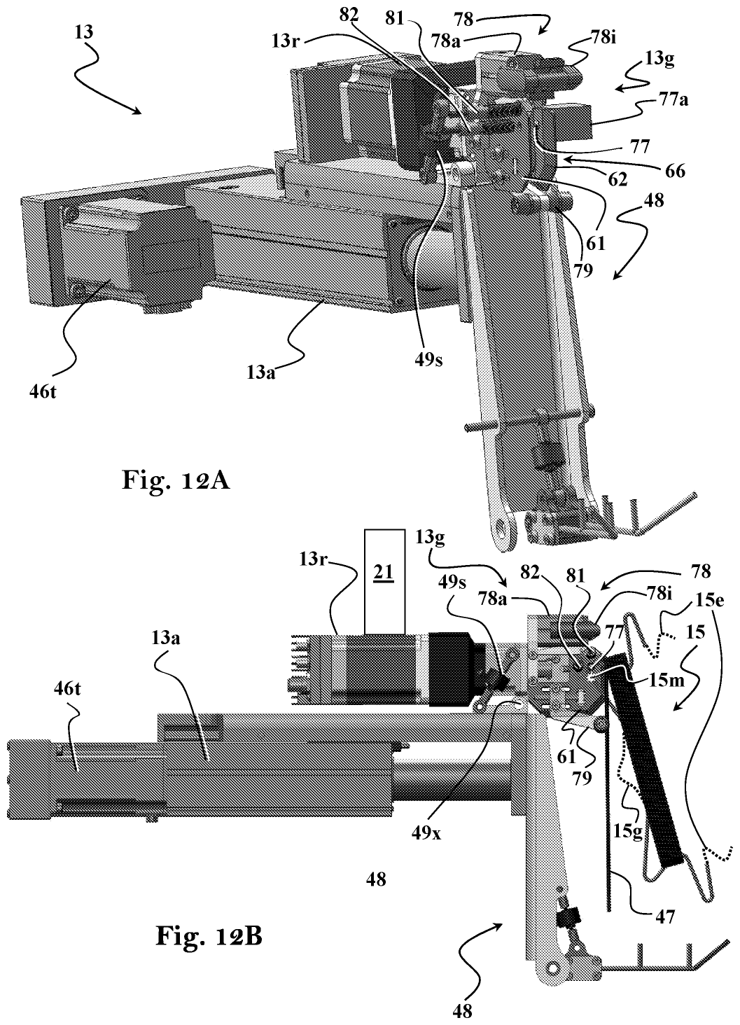

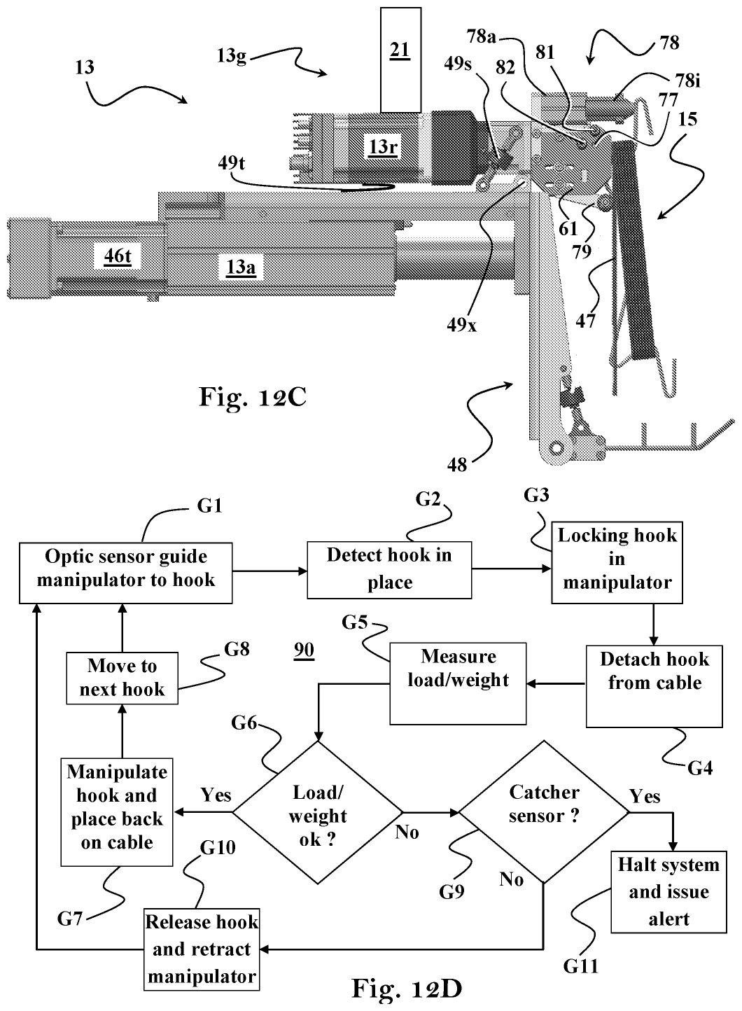

FIGS. 12A to 12C schematically illustrate a possible arrangement of the robotic arm system 13 and its manipulator 13g according to some possible embodiments. In this embodiment the fingers 61,62 of the manipulator 13g are implemented by parallel plates, each having an edge tapering anteriorly and laterally, to thereby form a tapered opening 66 therebetween configured to receive a portion of a suspension device 15. With this configuration the manipulator 13g can be guided in the direction of the suspension device 15 to capture an upper, or bottom, portion thereof, and guide it towards a locking pin 77 of the manipulator 13g.

At least one of the fingers 61,62 can be controllably movable with respect to the other for gripping an upper, or lower, loop portion of the suspension device 15 therebetween. Optionally, but is some embodiments preferably, fingers 61,62 are fixedly coupled to the robotic arm 13 so as to maintain a fixed gap therebetween. The manipulator 13g in this embodiment utilizes one or more sensors 81,82 in one or more of its fingers 61,62 for sensing the receipt of the upper, or lower, loop portion of the suspension device 15 therebetween. In this specific and-non limiting example two sensors (e.g., proximity sensors, contact sensors, optical sensors) 81,82 are installed in finger 61, and the locking pin 77 and its actuator are installed in the other finger 62.

The control unit (17) of the system can be configured to receive and process signals/data generated by the sensors 81,82, to determine therefrom receipt of the upper, or lower, loop portion of the suspension device 15 between the fingers 61,62 and over a pin opening in the finger 62. Upon determining that the upper, or lower, loop portion of the suspension device 15 is properly located over the pin opening between the fingers 61,62 the control unit (17) generated control signals for pushing the locking pin 77 towards a respective opening formed in the oppositely located finger 61, to thereby lock the suspension device 15 between the fingers 61,62.

Referring now to FIGS. 12B and 12C, in some embodiments the manipulator 13g comprises an immobilizing mechanism 78 having a controllably movable immobilizing element 78i configured to move (by actuator 78a) towards an upper portion of the suspension device 15 after it is locked (by actuator 77a) by locking pin 77, so as to prevent angular motion of the suspension device 15 about the locking pin 77. For this purpose, the manipulator 13g comprises in some embodiments a bottom abutment (stopper) structure 79 fixedly coupled to a bottom portion of the manipulator 13g and configured for abutment of a portion of the suspension device 15 extending below the loop portion locked by the locking pin 77. As seen in FIG. 12C, as the immobilizing element 78i is moved towards the suspension device and pushes an upper portion thereof anteriorly, the portions of suspension device that are below the locking pin 77 are pushed posteriorly until contact thereof with the bottom abutment structure 79 is established.

In this state the suspension device is locked between the fingers 61,62 and immobilized by the immobilizing element 78i and the abutment structure 79, so as to prevent rotary movement thereof about the locking pin 77. After locking and immobilizing the suspension device 15 by the locking pin 77, and the immobilizing element 78i and the abutment structure 79, the manipulator 13g can be rotated one or more 180° turns for releasing, or spooling, the twining wire 47.

A weighing mechanism can be coupled to the robotic arm system 13 to generate signals/data indicative of the gripping of the suspension device 15 by the manipulator 13g. In this embodiment the manipulator 13g and its actuator 13r are hinged to the robotic arm 13 by pivot 49x for slight rotary movement thereof thereabout. A load/pressure/strain sensor 49s is used to connected a portion e.g., based body, of the manipulator 13g to the robotic arm 13, against a pushing force applied thereto by an clastic element e.g., torsion spring, 49t. Accordingly, a constant load is measured by the load/pressure/strain sensor 49s before manipulation of the suspension device 15 by the manipulator 13g, due to the force applied thereover by the elastic element 49t.

Upon locking and immobilizing the suspension device 15 by the manipulator 13g, and lifting the robotic arm 13 to detach the suspension device 15 from the cable (14), the load/pressure/strain sensor 49s will further measure the weight of the plant P (or some portion thereof) attached to the twine 47 of the suspension device 15. Namely, the robotic arm system 13 can this way weigh each plant P which suspension device 15 is manipulated by the manipulator 13g. In some embodiments the weights measured by the load/pressure/strain sensor 49s for each plant P are recorded and monitored over time to detect anomalies in the plants' growth and/or the growth management systems therefore used (e.g., irrigation).

In possible embodiments specially designed suspension devices 15 adapted to facilitate and improve utilization of the plants management systems disclosed herein, are used for supporting the treated plants (P). For example, the length of the suspension device 15 is reduced in some embodiments to provide a relatively short suspension devices e.g., having a length between 9 to 11 cm, for exploiting the ability of the manipulator 13g to carry out several half-turn (180°) manipulations of each suspension device 15 i.e., for releasing a desired length of the twine 47, and to substantially reduce the moments affected by the weight of the plant (P) over the robotic arm 13. In some embodiments the suspension devices 15 include special marking(s) 15m e.g., color and/or carved patterns/markers, configured for quick detection of a grabbing portion of the suspension device 15. Optionally, a coupling curved-extension 15e is provided at the extremities of the suspension devices 15 for allowing manipulating the suspension devices 15 while contacting the (trellis) cable (14), so that a portion of the load of the plant's weight is maintained on the cable (14), for reducing the loads over the robotic arm 13 and/or its manipulator 13g. Additionally, or alternatively, the suspension devices 15 are configured with a curved central grabbing portion 15g protruding outwardly from the suspension devices 15 and their spooled twine, for facilitating capture thereof and manipulation by the manipulator 13g.

FIG. 12D shows a flowchart of a process 90 of plant treatment/management according to some possible embodiments. The process 90 can be implemented by hardware and/or software components of the control unit (17) of the system. The process 90 can start in (G1) guiding the manipulator (13g) to a suspension device (hook, 15) based on measurement signals/data form the optical sensor (21 e.g., imager). The measurement data/signals generated by the one or more sensor(s) (81,82) provided in the finger(s) (61 and/or 62) of the manipulator (13g) can be then used (G2) to detect receipt of the suspension device (15) therein, and the placement of one of its loops over the opening of the locking pin (77). In this state the suspension device (15) can be locked (G3) to the manipulator (13g) by pushing the locking pin (77) into the loop of the suspension device (15) placed within the manipulator (13g).

The robotic arm system (13) can be then (G4) lifted/elevated to detach the suspension device (15) from the cable (14). In this state weight/load measurements can carried out (G5) (e.g., using load/pressure/strain sensor 49s) for collecting measurement data/signals indicative of the weight of the plant (P) coupled to the suspension device (15) via its twine (47). The measured load/weight data/signals can be processed to determine (G6) if they are within acceptable ranges. This step may be used to determine is an additional weight of a coupled plant (P) is indeed experienced by the robotic arm (13), and if so, to further determine if the measured load/weight signals/data are indicative of any anomalies concerning the plant's growth and/or its treatment/management systems (e.g., irrigation, fertilizing, drainage, etc).

If the measure load/weight signals/data are indicative an additional weight of a coupled plant (P), the suspension device (15) can be manipulated (G7), and the suspension device (15) can be then placed back on the cable (14). The process 90 can then proceed (G8) to move the system until a next suspension device (15) is thereby detected, and carrying out the above steps (G1 to G7) to manipulate it. If the measure load/weight signals/data are not indicative an additional weight of a coupled plant (P), then (G9) measurement data/signals from sensor(s) (48s) of the catcher assembly (48) are used to determine if the suspension device was inadvertently released from the manipulator (13g). If the measurement data/signals from sensor(s) (48s) of the catcher assembly (48) are indicative of sudden excess load/weight applied on over the catcher assembly (48) the process 90 is halted (G11) and an alert may be issued by the control unit (17) to indicate that user intervention is required.

If the measurement data/signals from sensor(s) (48s) of the catcher assembly (48) are indicative of sudden excess load/weight applied thereover, then (G10) the lock fo the manipulator (13g) may be released to retract the manipulator (13g) away from the suspension device and restart the process 90 (G1).

It is noted however that in possible embodiments the measurement data/signals from sensor(s) (48s) of the catcher assembly (48) and/or from the load/pressure/strain sensor 49s are continuously/periodically and independently monitored to detect accidental release of the suspension device (15). Accordingly, step G11 can be carried out at any stage of the process 90 to halt the system and/or issue an alert, whenever the measurement data/signals from sensor(s) (48s) of the catcher assembly (48) are indicative of that a plant/suspension device is caught by the catcher assembly (48), and/or that the measurement data/signals from the load/pressure/strain sensor 49s are indicative of a sudden release of the suspension device (15) from the manipulator i.e., a sudden drop of the weight measured by the load/pressure/strain sensor 49s.

Terms such as top, bottom, front, back/rear, right, and left and similar adjectives in relation to orientation of the objects and system components, refer to the manner in which the illustrations are positioned on the paper, not as any limitation to the orientations in which the apparatus can be used in actual applications. It should also be understood that throughout this disclosure, where a process or method is shown or described, the steps of the method may be performed in any order or simultaneously, unless it is clear from the context that one step depends on another being performed first.

As described hereinabove and shown in the associated figures, the present disclosure provides an agricultural automated plants growth management/treatment system, and related methods. While particular embodiments of the invention have been described, it will be understood, however, that the invention is not limited thereto, since modifications may be made by those skilled in the art, particularly in light of the foregoing teachings. As will be appreciated by the skilled person, the invention can be carried out in a great variety of ways, employing more than one technique from those described above, all without exceeding the scope of the claims.

1. A plants management and/or treatment system comprising:
at least one robotic arm system configured to reciprocally move a robotic arm thereof along a longitudinal axis thereof towards or away suspension devices placed on a cable, the longitudinal axis of said robotic arm being substantially perpendicular to a direction of gravitational forces experienced by said at least one robotic arm, each one of said suspension devices supports at least one plant coupled to the suspension device;
a manipulator coupled to said at least one robotic arm and configured to receive and immobilize one of said suspension devices between gripping fingers thereof and manipulate it to adjust at least one of suspension height of the plant coupled to said suspension device, or location of said suspension device along said cable; and
at least one sensing unit coupled to said at least one robotic arm such that its field-of-view is not affected by the manipulation of said suspension device by said manipulator, said at least one sensing unit configured to detect location of one of said suspension devices suspended from said cable, and generate signals/data to cause said at least one robotic arm to reciprocally move along said longitudinal axis to grip said suspension device and manipulate it.

2. The system of claim 1 wherein the manipulator is configured to release a portion of a twine/wire spooled on some portion of the suspension device, or to spool a portion of the released twine/wire therefrom, for the adjusting of the suspension height of the plant coupled to a free end of said twine/wire.

3. The system of claim 1 comprising either an adjustable mast or a scissor elevation mechanism, configured to elevate or lower the at least one robotic arm system.

4. The system of claim 1 wherein each robotic arm system is coupled to one or both of a respective horizontal and a respective vertical rail for sliding motion thereover.

5. (canceled)

6. The system of claim 1 comprising two robotic arm systems configured to simultaneously manipulate suspension devices located on respective two different cables at two opposing sides of said system.

7. The system of claim 1 comprising an arm rotating unit configured to apply yaw rotatory motion to the at least one robotic arm.

8. (canceled)

9. The system of claim 1 comprising a movable platform configured to move the at least one robotic arm substantially in parallel to the cable.

10. The system of claim 1 comprising a catcher assembly configured to catch plants and/or suspension devices accidentally detached from the manipulator and/or the cable.

11. The system of claim 10 comprising a sensing device configured to detect engagement of the catcher assembly with a plant and/or suspension device, wherein the system is configured to halt the system upon detection of accident release of the suspension device from the manipulator.

12. (canceled)

13. (canceled)

14. The system of claim 1 comprising a weighing mechanism coupled to the robotic arm system and configured to generate load/weight data/signals indicative of a weight of a plant, or some portion thereof, coupled to the suspension device, and a control unit configured and operable to collect, process and/or monitor, weight data/signals of plants supported by the suspension devices thereby manipulated and issue an alert if growth anomalies are thereby determined.

15.-17. (canceled)

18. The system of claim 14 wherein the control unit is configured to manipulate the suspension device whenever the load/weight data/signals from the weighing mechanism is indicative of a plant's weight over the robotic arm.

19. The system of claim 1 comprising an auxiliary arm coupled to the at least one robotic arm, said auxiliary arm configured to contact the cable and at least partially support the at least one robotic arm over the cable.

20. The system of claim 19 wherein the auxiliary arm is hinged to the at least one robotic arm.

21. The system of claim 20 wherein the auxiliary arm is coupled to the at least one robotic arm by an elastic element configured to pull the auxiliary arm towards the at least one robotic arm.

22. (canceled)

23. (canceled)

24. The system of claim 1 wherein at least one of the gripping fingers comprises at least one of the following:
a recess configured to receive a portion of the detected suspension device to thereby grip and immobilize said suspension device by the manipulator;
one or more projections configured to receive a portion of the detected suspension device to thereby grip and immobilize said suspension device by the manipulator; and
complementary male-female gripping elements configured to receive a portion of the detected suspension to thereby grip and immobilize said suspension device by the manipulator.

25. (canceled)

26. (canceled)

27. The system of claim 1 wherein the manipulator comprises a locking pin controllably movable for insertion into a loop of the suspension device.

28. The system of claim 27 comprising at least one of the following:
one or more sensors configured to indicate receipt of the suspension device therein, and placement of its loop over passage of the locking pin;
a controllably movable immobilizing element configured to anteriorly push an upper portion of the suspension device and rotate the same about the locking pin; and
an abutment structure configured to stop movement of lower portions of the suspension caused due to the movable immobilizing element.

29. (canceled)

30. (canceled)

31. A method for automated plants management and/or treatment, the method comprising:
detecting by at least one sensing unit coupled to at least one robotic arm a location of a suspension device suspended from a cable;
moving a manipulator in a non-gripping state thereof along a longitudinal axis of said robotic arm towards the suspension device, said suspension device is supporting at least one plant coupled to the suspension device, the longitudinal axis of aid robotic arm being substantially perpendicular to a direction of gravitational forces experienced by said at least one robotic arm;
receiving said suspension device between gripping fingers of said manipulator and changing said manipulator device into a gripping state in which said suspension device is immobilized between said gripping fingers; and
manipulating said suspension device by said manipulator for adjusting at least one of suspension height of the plant coupled to said suspension device, or location of said suspension device along said cable.

32. The method of claim 31 wherein the manipulating of the suspension device by the manipulator includes releasing a portion of a twine/wire spooled over a portion of the suspension device, or spooling a portion of the released twine/wire, for adjusting suspension height of the at least one plant, and/or receiving weight measurement data/signals for each of the plants supported by the suspension device manipulated by the at least one robotic arm.

33.-35. (canceled)

36. The method of claim 31 comprising detecting accidental release of the suspension device from the manipulator, and/or halting operations responsive to the detection of accidental release of the suspension device from the manipulator, and/or issuing an alert.

37. (canceled)
